(19) United States
(12) Patent Application Publication
(10) Pub. No.: US 2014/0127451 A1
(43) Pub. Date: May 8, 2014

(54) COMPOSITE LAMINATE, METHOD OF MANUFACTURE AND USE THEREOF

(71) Applicants: Benjamin D. Pilpel, Centennial, CO (US); Edward D. Pilpel, Avon, CT (US); D. Michael Gordon, Lone Tree, CO (US); Todd Hobbs, Montrose, CO (US); Drew Gordon, Centennial, CO (US)

(72) Inventors: Benjamin D. Pilpel, Centennial, CO (US); Edward D. Pilpel, Avon, CT (US); D. Michael Gordon, Lone Tree, CO (US); Todd Hobbs, Montrose, CO (US); Drew Gordon, Centennial, CO (US)

(73) Assignee: GORDON HOLDINGS, INC., Englewood, CO (US)

(21) Appl. No.: 14/071,324

(22) Filed: Nov. 4, 2013

Related U.S. Application Data
(60) Provisional application No. 61/722,448, filed on Nov. 5, 2012.

(51) Int. Cl. B32B 5/12; B62D 33/04; B32B 27/08; F41H 5/04

(52) U.S. Cl. CPC B32B 5/12; F41H 5/04; B62D 33/046; B32B 27/08
USPC 428/113; 156/60; 156/279; 89/36.02; 296/39.1; 296/184.1; 296/199; 428/516; 428/114

(57) ABSTRACT

A composite laminate comprises a plurality of composite plies including at least a first composite ply and a second composite ply. The first composite ply and the second composite ply each comprises a plurality of fibers in a thermoplastic matrix comprising polyethylene. The plurality of composite plies are bonded together to form the composite laminate.

### CROSS-REFERENCE TO RELATED APPLICATIONS

This application claims priority to U.S. provisional patent application Ser. No. 61/722,448 filed on Nov. 5, 2012, the contents of which are hereby incorporated by reference in their entirety.

### TECHNICAL FIELD

The present disclosure is generally directed to composite laminate materials configured for use as liners and other structures in transportation applications, such as cargo carriers including trailers, and to methods of their manufacture.

### BACKGROUND

There are many types of cargo carriers including, but not limited to, freight transport vehicles, rail cars, air cargo carriers, over the road trailers such as refrigerated and non-refrigerated truck trailers, ships, and so forth. Cargo carriers typically include a cargo holding body or container. As an example, a typical trailer includes a roof, a floor and side walls extending between the roof, and a rear door for access to the cargo holding body. Wood has been employed as the material for the inner walls and/or liners of such a trailer. However, a problem with use of such material is that the wood is easily damaged during loading and unloading of the cargo holding body contents with the use of, e.g., fork lifts and other machine handling equipment. Also, another problem with the use of wood is the relatively high weight of the material, which can decrease the fuel efficiency during transport of the cargo and thus increasing shipping costs.

Accordingly, what is needed is an alternative, light weight and durable material for use as liners, panels including fire retardant ballistic panels, containers and other structures in applications such as, but not limited to, cargo carriers that can withstand the frequent impact of, e.g., fork lifts and other machine handling equipment during loading and unloading of the cargo contents and which can resist puncture during such operations. Thus, there is also a need in industries concerning armor or ballistic materials for, e.g., vehicles and personnel, particularly with respect to fire retardancy requirements.

### SUMMARY

According to aspects illustrated herein, there is provided a composite laminate. The composite laminate comprises a plurality of composite plies including at least a first composite ply and a second composite ply. The first composite ply and the second composite ply each comprise a plurality of fibers in a thermoplastic matrix comprising polyethylene. The plurality of composite plies are bonded together to form the composite laminate. Plies can be, in degrees (°), 0, 90, 37.5, 45 or any angle from one ply to another between 0 to 90, according to aspects illustrated herein.

According to other aspects illustrated herein, there is provided a fire resistant composite laminate. The laminate comprises a plurality of composite plies including at least a first composite ply and a second composite ply, the first composite ply and the second composite ply each comprising a plurality of fibers in a thermoplastic matrix comprising polyethylene and comprising polyvinylidene fluoride (PVDF), wherein the plurality of composite plies are bonded together to form the fire resistant composite laminate.

According to further aspects illustrated herein, there is provided a method of making a composite laminate. The method comprises providing at least a first composite ply and a second composite ply, each of the first and second composite ply comprising a plurality of fibers in a thermoplastic matrix comprising polyethylene. The method further comprises disposing the plurality of fibers in the first composite ply cross-wise to the plurality of fibers in the second composite ply; and bonding the plurality of plies together to form a panel, wherein the panel achieves a puncture resistance level greater than or equal to about 200 pounds of force.

### BRIEF DESCRIPTION OF THE DRAWINGS

FIG. 1 is a schematic illustration of a composite laminate comprising a first composite ply and a second composite ply, according to embodiments;

FIG. 1A is a schematic illustration of a non-limiting example of layers/construction components, which could be included in the laminate of FIG. 1;

FIG. 2 is a schematic illustration of a laminator, which can be employed to, e.g., manufacture a composite ply of the composite laminate of FIG. 1;

FIG. 3 is a general schematic depiction of an apparatus used to produce a composite laminate, according to embodiments;

FIG. 4 is a schematic perspective view of an unwind station of the apparatus of FIG. 1;

FIG. 5 is a schematic perspective view of a support roller assembly of the unwind station of FIG. 4;

FIG. 6 is a schematic perspective view of a material guide assembly of the unwind station of FIG. 4;

FIG. 7 is a schematic perspective view of a tacking station with an optional second ply station of the apparatus of FIG. 1;

FIG. 8 is a schematic perspective view of the tacking station of FIG. 7 with first ply composite materials and a cross-ply composite material for tacking thereon;

FIG. 9 is a is a schematic perspective view of an oven station of the apparatus of FIG. 1;

FIG. 10 is an elevation view of one or more processing modules of the apparatus of FIG. 1;

FIG. 11 is a perspective view of a heated calendar roll assembly of the one or more processing modules of FIG. 10.

FIG. 12 is an exploded perspective view of a rollover for the heated calendar roll assembly of the one or more processing modules of FIG. 10;

FIG. 13 is a perspective view of a cooled calendar roll assembly of the one or more processing modules of FIG. 10;

FIG. 14 is a perspective view of the uptake station of the apparatus of FIG. 1;

FIG. 15 is a process flow chart to produce a composite laminate, according to embodiments;

FIG. 16 is a rear view of a refrigerated trailer including a thermoplastic composite liner, according to embodiments;

FIG. 17 shows a corrugated panel, according to embodiments;

FIG. 18 is a rear view of an over the road trailer including a non-corrugated panel, according to embodiments;

FIG. 19 is a perspective view of an over the road trailer fitted with an aerodynamic side skirt comprising a composite laminate, according to embodiments;

FIG. 20 is a side elevation view of a refrigerated trailer including a thermoplastic composite liner, according to embodiments;

FIG. 21 is a sectional view of a portion of the trailer of FIG. 20 as seen from a plane indicated by line 2-2 in FIG. 21 showing the thermoplastic composite liner of FIG. 21;

FIG. 22 is a perspective view of an air cargo container including a thermoplastic composite liner, according to embodiments;

FIG. 23 is a perspective view of a rail car including a thermoplastic composite liner, according to embodiments;

FIG. 24 is a perspective view of an intermodal container including a thermoplastic composite liner, according to embodiments;

FIG. 25 is a bar graph depicting the results of puncture resistance testing for various liner samples; and

FIG. 26 graphically depicts further puncture resistance testing results of various liner samples.

### DETAILED DESCRIPTION

One aspect disclosed herein is directed to a composite laminate that includes at least two composite plies, e.g., a first composite ply and a second composite ply, bonded together. Each ply comprises a plurality of fibers. The plurality of fibers of each of the first composite ply and the second composite ply are impregnated with a thermoplastic matrix material comprising polyethylene, which is further described below, to form wetted, very low void composite plies, optionally to the substantial exclusion of thermosetting matrix material, according to embodiments. Optionally, the fibers of each ply are encapsulated in the thermoplastic matrix material.

In an embodiment, the plurality of fibers in the first composite ply are substantially parallel to each other, and the plurality of fibers in the second composite ply are substantially parallel to each other. Thus, the fibers of each ply are longitudinally oriented (that is, they are aligned with each other), and continuous across the ply, according to an embodiment. A composite ply is sometimes referred to herein as a ply or sheet and characterized as “unidirectional” in reference to the longitudinal orientation of the fibers, according to embodiments.

In further accordance with embodiments disclosed herein, the plurality of fibers in the first composite ply are disposed cross-wise (transverse) to the plurality of fibers in the second composite ply. For example, the fibers in the first composite ply are disposed cross-wise to the plurality of fibers in the second composite ply at an angle of greater than about 0 degrees to about 90 degrees, specifically at an angle of about 15 degrees to about 75 degrees. It is further noted that 0 degrees to about 90 degrees also could be employed, according to embodiments.

Additionally, the plurality of fibers in the first composite ply are the same or different from the plurality of fibers in the second composite ply, according to embodiments. Thus, various types of fibers, including different strength fibers, are used in a composite ply, according to embodiments. Example fibers include E-glass and S-glass fibers. E-glass is a low alkali borosilicate glass with good electrical and mechanical properties and good chemical resistance. Its high resistivity makes E-glass suitable for electrical composite laminates. The designation “E” is for electrical.

S-glass is a higher strength and higher cost material relative to E-glass. S-glass is a magnesia-alumina-silicate glass typically employed in aerospace applications with high tensile strength. Originally, “S” stood for high strength. Both E-glass and S-glass are particularly suitable fibers for use with embodiments disclosed herein.

E-glass fiber may be incorporated in a wide range of fiber weights and thermoplastic polymer matrix material. The E-glass ranges from about 10 to about 40 ounces per square yard (oz./sq. yd.), specifically about 19 to about 30, and more specifically about 21.4 to about 28.4 oz./sq. yd. of reinforcement, according to embodiments. As a non-limiting example, a minimum weight of a cross (X) ply could be approximately 18 oz./sq. yd. of composite. At 70% fiber by weight, the reinforcement would be 70% of 18 oz. The upper end for a scuff plate is in the range of 250 to 300 oz./sq. yd. for multiple layers of cross ply, tri ply or quad ply, according to non-limiting embodiments.

The quantity of S-glass or E-glass fiber in a composite ply optionally accommodates about 40 to about 90 weight percent (wt. %) thermoplastic matrix, specifically about 50 to about 85 wt. % and, more specifically, about 60 to about 80 wt. % thermoplastic matrix in the ply, based on the combined weight of thermoplastic matrix plus fiber.

Other fibers may also be incorporated, specifically in combination with E-glass and/or S-glass, and optionally instead of E- and/or S-glass. Such other fibers include ECR, A and C glass, as well as other glass fibers; fibers formed from quartz, magnesia alumuninosilicate, non-alkaline aluminoborosilicate, soda borosilicate, soda silicate, soda lime-aluminosilicate, lead silicate, non-alkaline lead boroalumina, non-alkaline barium boroalumina, non-alkaline zinc boroalumina, non-alkaline iron aluminosilicate, cadmium borate, alumina fibers, asbestos, boron, silicone carbide, graphite and carbon such as those derived from the carbonization of polyethylene, polyvinylalcohol, saran, aramid, polyamide, polybenzimidazole, polyoxadiazole, polyphenylene, PPR, petroleum and coal pitches (isotropic), mesophase pitch, cellulose and polyacrylonitrile, ceramic fibers, metal fibers as for example steel, aluminum metal alloys, and the like.

Where very high performance is required and cost justified, high strength organic polymer fibers formed from an aramid exemplified by Kevlar or various carbon fibers may be used. High performance, unidirectionally-oriented fiber bundles generally have a tensile strength greater than 7 grams per denier. These bundled high-performance fibers may be any one of, or a combination of, aramid, extended chain ultra-high molecular weight polyethylene (UHMWPE), poly [p-phenylene-2,6-benzobisoxazole] (PBO), and poly[diimidazo pyridinylene (dihydroxy) phenylene] (M5). The use of these very high tensile strength materials is particularly useful for composite panels having added strength properties.

Accordingly, fiber types known to those skilled in the art can be employed without departing from the broader aspects of the embodiments disclosed herein. For example, aramid fibers such as those marketed under the trade names Twaron, and Technora; basalt, carbon fibers such as those marketed under the trade names Toray, Fortafil and Zoltek; Liquid Crystal Polymer (LCP), such as, but not limited to, LCP marketed under the trade name Vectran. Based on the foregoing, embodiments also contemplate the use of organic, inorganic and metallic fibers either alone or in combination.

The composite plies optionally include fibers that are continuous, chopped, random comingled and/or woven, according to embodiments. In particular embodiments, composite plies as described herein contain longitudinally oriented fibers to the substantial exclusion of non-longitudinally oriented fibers.

Since fibers within a composite ply are longitudinally oriented, according to embodiments, a composite ply in a composite laminate can be disposed with the fibers in a specified relation to the fibers in one or more other composite plies.

In a particular embodiment, fibers within a tape or ply are substantially parallel to each other, and the composite laminate comprises a plurality of plies with the fibers of one ply being disposed cross-wise in relation to the fibers in an adjacent ply, for example, at an angle of up to about 90 degrees relates to the fibers in the adjacent ply. The fibers are evenly distributed across the ply, according to embodiments. Other examples include tape comprising fibers disposed in a thermoplastic matrix, and cross-ply tapes or laminates, e.g., material comprising two plies of fibers in a thermoplastic matrix material with the fibers in one ply disposed at about 90 degrees to the fibers in the other ply.

The thermoplastic matrix of one or more plies of the composite laminates described herein comprises a polymeric matrix, specifically a thermoplastic matrix comprising polyethylene, according to embodiments. It has herein been determined that the use of polyethylene in the thermoplastic matrix material results in a composite laminate having improved puncture resistance with less weight per unit of puncture protection compare to, e.g., polypropylene based composite laminates. Polyethylene also is more consistent in pricing than polypropylene, which tends to be highly variable in price due, in part, to the complex manufacturing processes needed to produce the propylene monomer. As described in further detail below, because the weight of a polyethylene composite laminate is less than, e.g., a polypropylene composite laminate, more cargo can be carried in a given container made or lined with such a material, which improves fuel efficiency and cost effectiveness in, e.g., trucks, railcars and ships in which they are used.

According to embodiments, copolymers of polyethylene and polypropylene are also useful as the thermoplastic matrix. For example, copolymers with more than about 50 wt. % polyethylene are useful with additions of polypropylene of up to about 50 wt. %, depending upon the application and property requirements thereof.

In further embodiments, the thermoplastic matrix of one of more of the plies comprises coextruded polyethylene and polyethylene terephthalate (sometimes written as poly(ethylene terephthalate)), commonly abbreviated as PET, in any suitable weight percent combinations. For example, PET polymers that are employed, according to embodiments, include thermoplastic PET polymer resins used in synthetic fibers; beverage, food and other liquid containers; thermoforming applications; and engineering resins in combination with glass fiber. PET homopolymers may be modified with comonomers, such as CHDM or isophthalic acid, which lower the melting temperature and reduce the degree of crystallinity of PET. Thus, the resin can be plastically formed at lower temperatures and/or with lower applied force. These PET homopolymers and copolymers are coupled with an optional release film for, e.g., later painting and such optional layers can also be laminated to the base composite structure, according to embodiments.

Accordingly, the polymeric matrix material for use in various embodiments disclosed herein comprises a polyethylene thermoplastic polymer. Thermoplastic loading by weight can vary depending upon the physical property requirements of the intended use of the product. It is noted that polyethylene is classified into different categories, which are mostly based on density and branching, and the mechanical properties of the polyethylene depend on variables such as the extent and type of branching, crystal structure and molecular weight. Particular examples include low-density polyethylene (LDPE), ultra-high-molecular-weight polyethylene (UHMWPE), ultra-low-molecular-weight polyethylene (ULMWPE or PE-WAX), high-molecular-weight polyethylene (HMWPE), high-density polyethylene (HDPE), high-density cross-linked polyethylene (HDXLPE), cross-linked polyethylene (PEX or XLPE), medium-density polyethylene (MDPE), linear low-density polyethylene (LLDPE), very-low-density polyethylene (VLDPE), and combinations thereof. Particularly useful types of polyethylene include HDPE, LLDPE and especially LDPE, as well as combinations thereof. Further details regarding particular properties of various types of polyethylene for use in the thermoplastic matrix described herein, according to embodiments, are set forth below.

LDPE has a density range of 0.910-0.940 g/cm³ and a high degree of short and long chain branching. Accordingly, the chains typically do not tightly pack into the crystal structure. Such material does exhibit strong intermolecular forces as the instantaneous-dipole induced-dipole attraction is less. This results in a lower tensile strength and increased ductility. LDPE is created by free radical polymerization. The high degree of branching with long chains gives molten LDPE unique and desirable flow properties.

UHMWPE is a polyethylene with a molecular weight in the millions, typically between about 3 and 6 million. The high molecular weight makes UHMWPE a very tough material, but can result in less efficient packing of the chains into the crystal structure as evidenced by densities of less than high density polyethylene (for example, 0.930-0.935 g/cm³). UHMWPE can be made through any catalyst technology, with Ziegler catalysts being typical. As a result of the outstanding toughness and cut of UHMWPE, wear and excellent chemical resistance, this material is useful in a wide range of diverse applications.

HDPE has a density of greater than or equal to 0.941 g/cm³. HDPE has a low degree of branching and thus strong intermolecular forces and tensile strength. HDPE can be produced by chromium/silica catalysts, Ziegler-Natta catalysts and/or metallocene catalysts. The lack of branching is ensured by an appropriate choice of catalyst (for example, chromium catalysts or Ziegler-Natta catalysts) and reaction conditions.

PEX (also denoted as XLPE) is a medium to high-density polyethylene containing cross-link bonds introduced into the polymer structure, which change the thermoplast into an elastomer. High-temperature properties are thus improved, flow reduced and chemical resistance enhanced.

MDPE has a density range of 0.926-0.940 g/cm³. MDPE can be produced with use of chromium/silica catalysts, Ziegler-Natta catalysts and/or metallocene catalysts. MDPE has good shock and drop resistance properties. This material also is less notch sensitive than HDPE and also exhibits better stress cracking resistance than HDPE.

LLDPE has a density range of 0.915-0.925 g/cm³. LLDPE is a substantially linear polymer with a significant number of short branches, commonly made by copolymerization of ethylene with short-chain alpha-olefins (for example, 1-butene, 1-hexene and 1-octene). LLDPE has higher tensile strength than LDPE, and exhibits higher impact and puncture resistance than LDPE. LDPE also exhibits properties such as toughness, flexibility and relative transparency.

VLDPE has a density range of 0.880-0.915 g/cm³. VLDPE is a substantially linear polymer with high levels of short-chain branches, commonly made by copolymerization of ethylene with short-chain alpha-olefins (for example, 1-butene, 1-hexene and 1-octene). VLDPE is typically produced using metallocene catalysts due to, for example, the greater co-monomer incorporation exhibited by these catalysts. VLDPEs also can be used as impact modifiers when blended with other polymers.

In addition to the particular polymers noted above, copolymers/combinations of the any of the foregoing are contemplated for use according to embodiments disclosed herein. As a further non-limiting example, in addition or alternative to copolymerization with alpha-olefins, ethylene (or polyethylene) can also be copolymerized with a wide range of other monomers and ionic compositions that create ionized free radicals. Examples include vinyl acetate, the resulting product being ethylene-vinyl acetate copolymer (EVA), and/or suitable acrylates.

Accordingly, in embodiments disclosed herein, the thermoplastic matrix of one or more composite plies of the composite laminates described herein comprises polyethylene, alone or in combination with other polymers/copolymers/constituents. For instance, polyethylene can be employed as the matrix material along with a high molecular weight thermoplastic polymer, including but not limited to, polypropylene, polyamide (nylon), PEI (polyetherimide) and copolymers thereof, polyvinylidene fluoride (PVDF), polyethylene terephthalate, polyphenylene sulfide (PSS), polyether ether ketone (PEEK), fluoro polymers in general and other engineering resins, as well as combinations of any of the foregoing. It is noted that a thermoplastic matrix material comprising polyvinylidene fluoride (PVDF) is particularly advantageous to impart fire resistant properties to the resultant composite. Accordingly, polyvinylidene fluoride (PVDF) may be employed in the thermoplastic matrix material in any suitable amount to impart desired fire resistance/retardant characteristics, and in any combination with the other materials described herein, according to embodiments. Suitable amounts of the PVDF include, but are not limited to, e.g., at least about 0.2 wt. % PVDF, between about 0.5 wt. % and about 20 wt. % PVDF and between about 1 w % and about 15 wt. % PVDF, in the thermoplastic matrix based on the wt. % of the thermoplastic matrix.

According to embodiments, a composite ply contains about 60 to about 10 wt. % thermoplastic matrix, specifically about 50 to about 10 wt. %, and more specifically about 40 to about 15 wt. %. Other exemplary ranges include about 40 to about 20 wt. % and about 30 to about 25 wt. %. It is noted that the foregoing weight percents are the weight percents of the thermoplastic matrix material of the ply, by weight of thermoplastic matrix material plus fibers.

In an exemplary embodiment, the fiber content in one or more composite plies is greater than about 50 wt. % (based upon weight of thermoplastic matrix plus fibers of the ply), specifically up to about 85 wt. %, and while various types of fibers are suitable, as described above, glass fibers are particularly suitable to achieve stiffness.

In a further exemplary embodiment, a composite laminate as described herein comprises at least a first ply and a second ply that are bonded together with their respective fibers in transverse relation to each other, and the first ply contains fibers that are different from the fibers in the second ply, wherein the thermoplastic matrix of one or both of the first and second plies comprises polyethylene. Thus, the composite laminate comprises at least two different kinds of fibers. In other words, fibers in at least a first composite ply are disposed in transverse relation to different fibers in an adjacent second composite ply, optionally at 90 degrees to the different fibers in the adjacent second composite ply. For ease of expression, a first composite ply and a second composite ply so disposed are sometimes described herein as being in transverse relation to each other (optionally at 90 degrees to each other) without specific mention of the fibers in each of the plies.

The phrase “different fibers” should be broadly construed to mean that the composite laminate includes least two composite plies whose fibers are made from two different materials or different grades of the same material. For example, as described in further detail below with respect to uses of the composite laminates described herein, one face of panel that comprises a composite laminate could be formed using Kevlar 129 fiber while the rear or back portion of the panel could be formed using a higher performing material.

Optionally, a composite laminate may also contain a composite ply disposed in parallel to an adjacent composite ply, particularly an adjacent ply that contains the same kind of fibers as in the first composite ply. The matrix material of at least one of ply, specifically all plies, comprises polyethylene. In addition, the matrix material can vary from ply-to-ply and can be in the form of different thermoplastics, polymers and combinations thereof. Therefore, a portion of a composite laminate incorporating a first fiber type can be formed in part by stacking individual composite plies one-on-the-next in parallel relation to each other.

In a particularly useful embodiment, a composite laminate comprises composite plies that contain E- and S-glass fibers respectively and that are oriented at angles of about 90° relative to one another in ply configuration.

An exemplary configuration for plies in a composite laminate having at least a first ply and a second ply is to have the second ply at 90° to the first ply. Other angles may also be chosen for desired properties with less than 90 degrees for the second sheet. Certain embodiments utilize a three sheet configuration wherein a first sheet is deemed to define a reference direction (i.e., zero degrees), a second sheet is disposed at a first angle (for example, a positive acute angle) relative to the first sheet (for example, about 45 degrees) and a third sheet is disposed at a second angle different from the first angle (for example, a negative acute angle) relative to the first sheet (that is, at an acute angle in an opposite angular direction from the second sheet (for example, about −45 degrees or, synonymously, at a reflex angle of about 315 degrees relative to the first sheet in the same direction as the second sheet). Thus the second and third sheets may or may not be perpendicular to each other. The thermoplastic matrix allows for easy relative motion of the fibers of adjacent plies during final molding of an article of manufacture.

According to further embodiments, at least two layers of composite plies of about the same areal density are arranged in a 0 to 90 degree configuration or, alternatively at angles from about 15 degrees to about 75 degrees. It is noted that the term “areal density” (typically expressed as pounds per square foot (lbs./sq. ft.)) can be employed to make comparisons of relative strength of different layer configurations. A higher areal density corresponds to a higher puncture strength of the layer. Also, composite laminates comprising at least two layers of composite plies, with the second layer having a greater areal density than the first layer, also are employed, according to embodiments. A non-limiting example of a suitable areal density for a panel comprising a composite laminate, according to embodiments, is about 1 to 10 lbs./sq. ft.

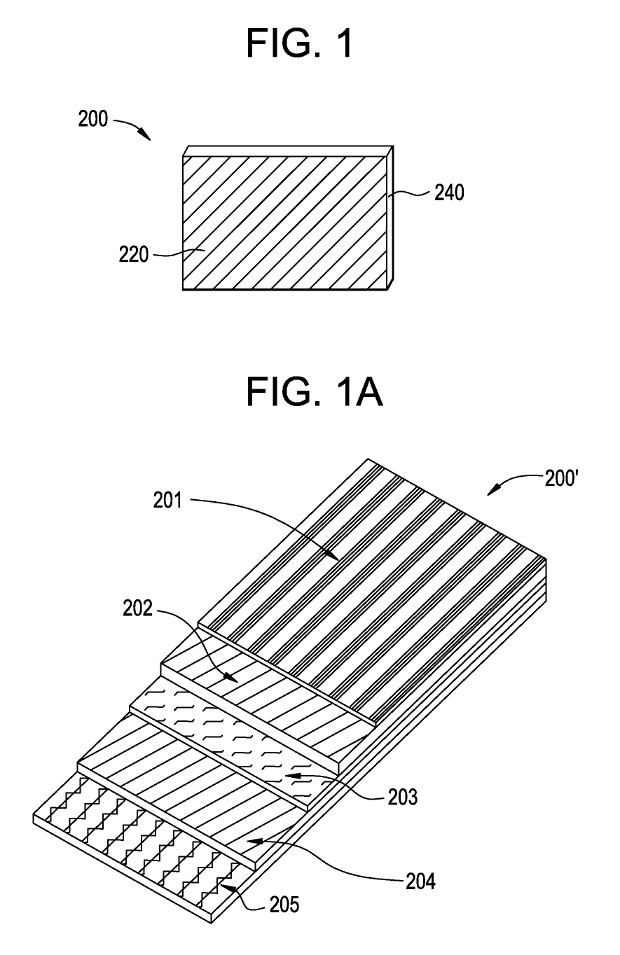

FIG. 1 schematically illustrates a non-limiting example of a composite laminate 200 comprising a first composite ply 220 and a second composite ply 240. As described above, the thermoplastic matrix material of at least one ply, typically both plies, comprises polyethylene. The composite plies 220 and 240 of this non-limiting example are each a unidirectional sheet or ply including longitudinally oriented fibers therein. Composite plies 220 and 240 can be separately produced in a continuous process and stored in individual rolls. A composite laminate as described herein, such as the exemplary composite laminate 200 illustrated in FIG. 1, comprises at least two composite plies, e.g., plies 220 and 240, bound together with their respective fibers in, e.g., transverse relation to each other.

FIG. 1A illustrates a non-limiting example of construction components/layers 200′, which could be included in the composite laminate 200 of FIG. 1. In this non-limiting embodiment shown in FIG. 1A, the laminate 200 comprises an outer layer 201, such as an outer film surface layer, barrier layer, additional composite layer, or combination thereof. As further shown in FIG. 1A, this outer layer 201 is deposited on a first inner layer 202, which is a cross-ply, tri-ply, quad ply or multiple ply material, and the first inner layer 202 is deposited on a second inner layer 203, which is a barrier film, core material, composite layer, or combination thereof. The second inner layer 203 is deposited on a third inner layer 204, which is a cross-ply, tri-ply, quad-ply or multiple ply material, as in the case of the first inner layer 202. The third inner layer 204 can be deposited on a scrim/veil 205, as further shown in FIG. 1A. It is noted that any suitable material, e.g., especially comprising polyethylene, could be employed for one or more of these layers. Moreover, FIG. 1A illustrates a non-limiting example of one particular arrangement for various layers and it will be appreciated that the order and materials therefore could vary as desired. Thus, components/layers 202-205 could be presented in any desired combination and order.

It is further noted that one or more additional layers could be employed in the construction shown in FIG. 1A. For example, one or more layers of high strength fibers, e.g., commingled thermoplastic fibers, glass fibers, and so forth, could placed anywhere in the layup (e.g., between the layers and/or as outer layers of the construction) to function as, e.g., a structural layer. An example for the structural layer is to use a commingled laminate product. A suitable commercially available product for this layer is TWINTEX®, which is a registered trademark by Fiber Glass Industries. According to the manufacturer, TWINTEX® is a thermoplastic glass reinforcement (roving) made of commingled E-Glass and polypropylene filaments, which can be woven into highly conformable fabrics. Consolidation is completed by heating the roving above the melting temperature of the polypropylene matrix (180° C.-230° C.) and applying pressure before cooling under pressure. Examples of glass content include, by weight, 53%, 60% and 70%. Examples of the weave include plain and twill. The size and shape of the structural layer, as well as the other layers of FIG. 1A, can be tailored as needed, depending upon the desired application.

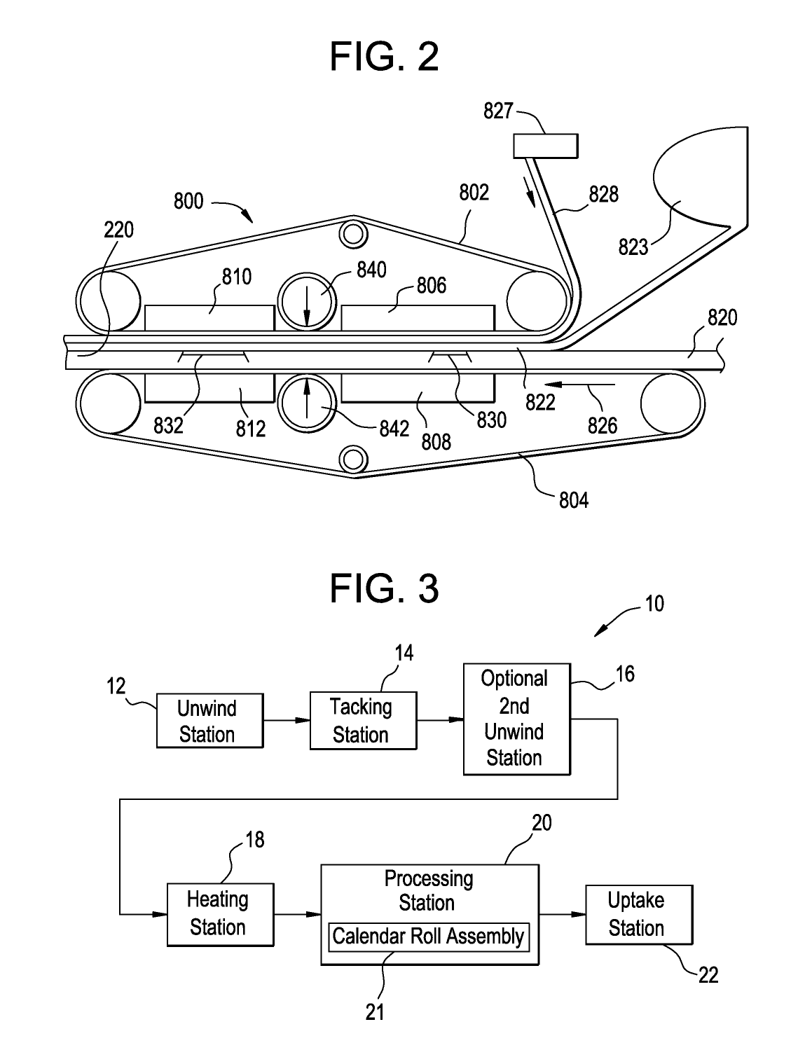

Various methods can be employed by which fibers in a ply may be impregnated with, and optionally encapsulated by, the thermoplastic matrix material, including, for example, a doctor blade process, lamination, pultrusion, extrusion, and so forth. For example, FIG. 2 schematically illustrates an example of a laminator 800 that can be used to make, e.g., the first composite ply 220 and/or second composite ply 240 of the composite laminate 200 shown in FIG. 1, as well as the composite laminate 200. It is noted that reference to composite laminate 200 including first composite ply 220 and second composite ply 240 with respect to the description of the operation of FIG. 2 below is merely for ease of illustrative purposes as an example. It should be understood that other composite plies of composite laminates and other composite materials, composite laminates, panels and so forth described herein may also be produced by the herein processes and apparatuses, according to embodiments.

More particularly, exemplary processing equipment suitable for making the fiber reinforced composite plies (e.g. first and second composite plies 220, 240 comprising a plurality of fibers in a thermoplastic matrix comprising polyethylene) described herein include a standard belt laminating system using coated belts, such as laminators commercially available from Maschinenfabrik Herbert Meyer GmbH located at Herbert-Meyer-Str., 1, D-92444 Roetz, Germany. An example of such a laminator is illustrated in the simplified schematic shown in FIG. 2. As shown therein, laminator 800 is a double belt press laminator comprising a first belt 804 and second belt 802. The laminator 800 includes integrated contact heaters 806, 808 forming a heating zone 830. As further shown in FIG. 2, the laminator 800 also includes contact coolers 810, 812 forming a cooling zone 832.

A plurality of fibers form a fiber mat 820, as shown in FIG. 2, for producing, e.g., the first composite ply 220 of FIG. 1. In the illustrated embodiment of FIG. 2, the fiber mat 820 is fed from a takeoff unit (not shown). A thermoplastic binder material (e.g., thermoplastic matrix material comprising polyethylene) 822 is fed from a takeoff unit 823 into a parallel path 826 with the fiber mat 820 to form, e.g., the first composite ply 220 of FIG. 1.

An optional thermoplastic topcoat layer 828 is shown feeding from a takeoff unit 827 and onto the fiber mat 820/thermoplastic binder 822, which form, e.g., the first composite ply 220. There may also be an optional release sheet layers (not shown) fed into contact with unfused composite material on both sides of the composite ply 220 in alternate embodiments.

It is noted that the optional topcoat layer 828 may advantageously be employed and tailored depending upon the end use of the resultant composite laminate, as described in further detail below. For example, the top coat layer 828 can be applied such that the surface of a liner, which is located in the interior of a cargo carrier and produced from the composite laminate, faces an interior of the cargo carrier, such as a container portion. The top coat layer 828 can be tailored to exhibit desirable properties such as durability and comprise a higher molecular weight than the liner material. Accordingly, improved scuff resistance and overall abrasion resistance of the interior surface could be achieved. Moreover, layers could be added to the structure to, e.g., increase puncture resistance, stiffness, antimicrobial/antibacterial properties, as needed by the particular end use application. For example, an optional layer could include a reflective layer as in, e.g., a metallic foil that would reflect heat and create a vapor barrier. This layer could be, e.g., at the surface or laminated within the structure, according to embodiments. Further optional layers also could include a veil layer for bonding on an additional structural layer such as an aluminum outside and/or external side wall to become, e.g., an integral trailer wall.

The fiber mat 820, binder material 822 and optional top coat 828 layers are pressed between the belts 802 and 804 to consolidate the materials into, e.g., the first composite ply 220 of the composite laminate 200, according to exemplary and non-limiting embodiments. The composite materials are typically heated gradually in heating zone 830 between the heaters 806 and 808 to a temperature suitable to soften the thermoplastic binder material 822 to fully saturate and wet the fiber mat 820 in the heating zone 830.

It should be appreciated that while one heating zone 830 is illustrated in FIG. 2, multiple heating zones could be employed to provide the desired temperature profile along the path 826. Processing through heating zone 830 allows the materials 820, 822 and optional top coat 828 to be laminated accurately with a high bonding strength. Upon exiting the heat zone 830, typically immediately after exiting the heating zone 830, these materials (820, 822 and 828) can be pressed together or calibrated to a set thickness with the use of one or more pressure rollers 840, 842. To assist in stabilization of these materials and the resultant formed, e.g., composite ply 220, the materials 820, 822 and optional 828 are then cooled in the cooling zone 832 by coolers 810, 812, which can be any type of suitable cooling mechanisms, before the fully fused composite ply 220 exits the double belt press laminator 800.

It is noted that as a result of, e.g., a flat gap over the heating zone 830 and the cooling zone 832 between the first and second belts 802, 804 allowing precise height adjustment, even rigid plates with a thickness of up to, e.g., about 150 millimeters (mm) can be laminated, according to embodiments. It will further be appreciated that the processing parameters can be varied and tailored to suit the specific materials employed. Generally, the heating time is a primary determinant of production speed along the path 826. The temperature can be varied in the heating zone 830, as needed. Similarly, the pressure of pressure rollers 840, 842 can be varied to obtain the desired integration of the thermoplastic material 822 into the fiber mat 820. The gap between the pressure rollers 840, 842 (level adjustment) can control the final dimension of, e.g., the composite ply 220 in conjunction with the height adjustment or gap between the first and second belts 802, 804. The temperature in the cooling zone 832 also can be varied, as needed, for line speed along the path 826, and in view of the particular thermoplastic binder material 822 being processed.

It will be appreciated that heating temperature, line speed, and/or roller pressure can influence the bonding of the layers together, as well as maintain fiber orientation. For example, too much pressure at the rollers in combination with too high of a temperature prior to entry of the material to the rollers can result in distortion of the fiber orientation. Increasing speed and/or decreasing roller pressure as needed can rectify such disorientation. However, such operation could potentially reduce the bond integrity and therefore increasing line speed as needed can be an effective solution to fiber distortion. Temperature, pressure and line speed are a function of matrix material type, e.g. plastic, or grade. For example, the temperature can range from about 200° F. to about 800° F. depending upon the thermoplastic type. The pressure applied to the laminate can range, e.g., between about 5 psi to about 1000 psi. The line speed is a function of heating and cooling capacity, and about 2 feet per minute to about 40 feet per minute is a typical range, according to embodiments.

It is further noted that other apparatuses can be employed to manufacture the composite materials disclosed herein. For example, a steel belted laminator, which is similar in some respects to the afore-described double belted, coated laminator 800 of FIG. 2, could be employed to produce, e.g., a composite ply, composite laminate, panel and so forth. One such suitable apparatus is a double belt press commercially available from AB Sandvik Process Systems, located at 2453 SE-81181 Sandvik, Sweden. According to the company's website, the double belt systems can operate using an isochoric system or an isobaric system. In the isochoric system, the pressing gap remains constant (constant uniform volume). The gap is constant irrespective of the applied pressure. The product thickness is determined by the belt gap and the pressure depends upon the infeed material tolerances. Active gap control also is possible. The types of press for the isochoric system include fixed roller, sliding shoe and circulating roller. Regarding processing parameters, in further accordance to the company's website, for example, a maximum line pressure is 70 kN/m and a maximum temperature is 280° C. (air) and 350° C. (IR) for the fixed roller type. Regarding the circulating roller type, a maximum pressure and temperature are 10 bar and 350° C. (oil), respectively. Regarding the sliding shoe type, a maximum pressure and temperature are 0.5 bar and 350° C. (oil), respectively.

In contrast to the isochoric system, with use of an isobaric press, the pressure is constant and height of the pressing gap varies depending on the properties of the product. Uniform material feed delivers a uniform product thickness and the applied pressure remains constant. Also, operation at high pressure is possible, along with active pressure control. A thin product can also be produced. Regarding processing parameters, in further accordance to the company's website, a maximum pressure and temperature are 70 bar and 300° C., respectively.

While, for example, a composite ply could be produced with use of the afore-described apparatus(es) and processes, according to embodiments, it is further noted that various other methods could be employed to, e.g., bond composite plies together to form a composite laminate in addition to, or as an alternative to the foregoing. Such methods include stacking the composite plies one on the next to form a composite laminate and applying heat and/or pressure, or using adhesives in the form of liquids, hot melts, reactive hot melts or films, epoxies, methylacrylates and urethanes to form the composite laminate panel. Sonic vibration welding and solvent bonding can also be employed. In general, a composite laminate can be constructed from a plurality of plies by piling a plurality of plies one on the next and subjecting the plies to heat and pressure, e.g., in a press, to melt adjacent plies together.

U.S. Pat. No. 8,201,608, assigned to the same assignee herewith, discloses suitable apparatuses and methods for making sheets of composite material. Such apparatuses and methods could be used to produce the composite laminate panels, materials and structures described herein. Accordingly, reference below is made to such apparatuses and processes, with modification of some reference numerals and so forth for tailoring to the composite laminates and structures described herein.

An example of a suitable apparatus, which can be used to produce, e.g., a composite laminate 200 of FIG. 1, among other composite laminates and structures disclosed herein, is shown by the general block depiction of FIG. 3 and denoted by reference numeral 10. As shown in FIG. 3, apparatus 10 comprises an unwind station 12. During operation, composite material such as, e.g., a composite ply comprising a plurality of fibers in a thermoplastic matrix comprising polyethylene is fed or unwound from rolls in the unwind station 12 for further processing, according to embodiments. The apparatus 10 further includes a tacking station 14 adjacent to the unwind station 12, where additional layers of composite material can be tacked onto the composite material being unwound from the unwind station 12. These additional layers can be configured so that the fibers forming part of the additional layers of composite material can be oriented at different angles relative to the fibers in the composite material being unwound from the unwind station 12. However, embodiments are not limited in this regard, as the fibers forming part of the additional layers can also be oriented substantially parallel to the fibers forming part of the composite being unwound from the unwind station 12. The apparatus 10 includes an optional second unwind station 16 adjacent to the tacking station, where at least one additional layer of composite material can be unwound from rolls of composite material thereon. These layers can be unwound on top of the composite material unwound from the first unwind station 12 and any additional layers added at the tacking station 14. There is a heating station 18 downstream from the tacking station 14, where layers of composite material are heated so that they can bond to one another. There is also a processing station 20 downstream from the heating station 18. The processing station 20 includes at least one calender roll assembly 21, as explained in greater detail below. An uptake station 22 is positioned downstream of the processing station 20 for winding composite material laminate thereon. The overall progress of composite material from the unwind station 12 to the uptake station 22 is referred to herein as “the process direction,” indicated by the arrows in FIG. 3. The terms “upstream” and “downstream” are sometimes used herein to refer to directions or positions relative to the process direction.

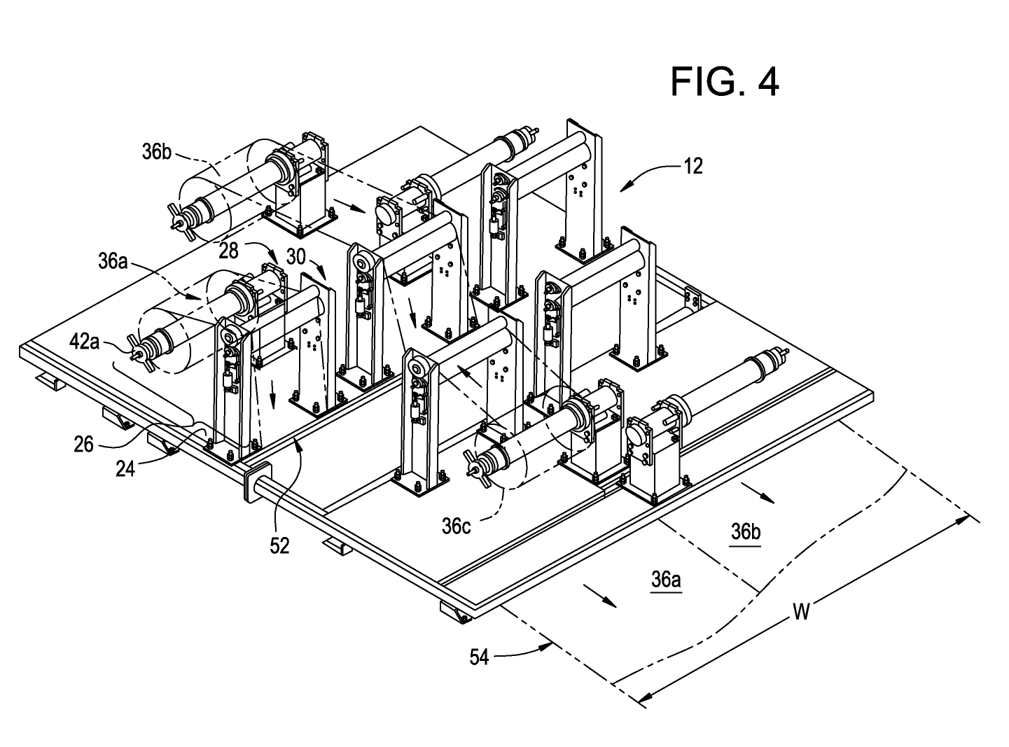

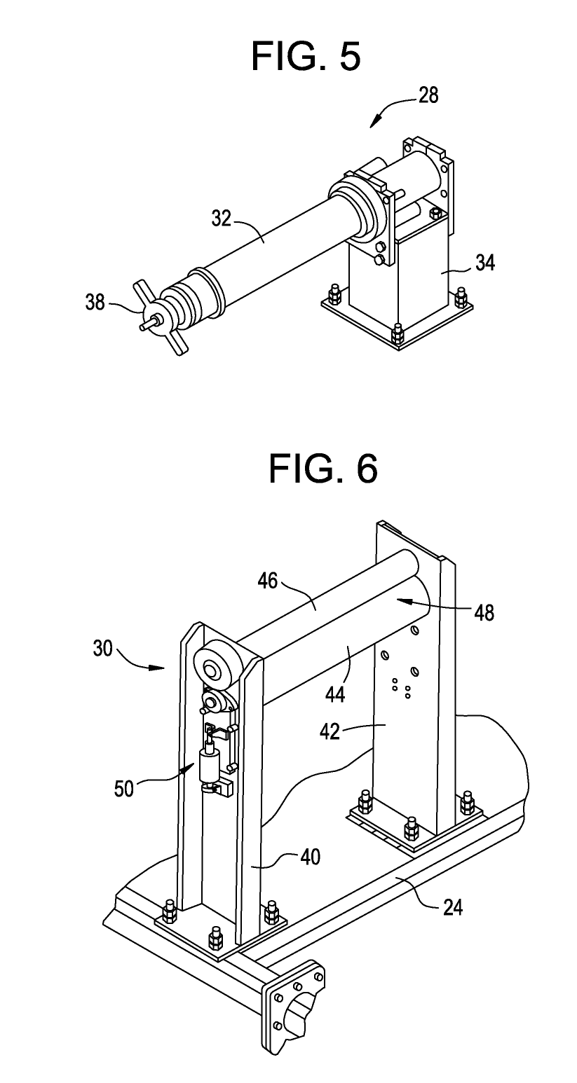

As shown in FIG. 4, and as described in afore-referenced U.S. Pat. No. 8,201,608, the unwind station 12 includes an unwind frame 24 on which are mounted five similarly configured roll support assemblies, one of which is indicated at 26. While the unwind station 12 has five roll support assemblies 26, embodiments are not limited in this regard as fewer than, or more than, five roll support assemblies can form part of the unwind station without departing from the broader aspects of the embodiments. The roll support assembly 26, like the other roll support assemblies shown in FIG. 4, includes a support roller assembly 28 (also seen in FIG. 5) and an associated material guide assembly 30 (also seen in FIG. 6). The support roller assembly 28 comprises a support roller 32 rotatably coupled to a pedestal 34, the pedestal being mounted to the unwind frame 24. Each support roller 32 is configured to carry a roll of composite material thereon, as indicated by the rolls of composite material 36a, 36b, 36c in FIG. 4. A locking cap 38 is removably mounted to the support roller 32 to removably retain a roll of composite material thereon. The locking cap 38 can be threaded onto the support roller 32, however, embodiments are not limited in this regard as the locking cap can be retained on the support roller in other manners known to those skilled in the pertinent art to which the present invention pertains. For example, the locking cap 38 could be bolted onto the support roller 32 or retained thereon via a snap ring. The support roller assembly 28 may include a support roller drive mechanism (not shown) or a support roller braking mechanism (not shown) to accelerate or retard the unwinding of the roll of composite material 36a on the support roller 32 to vary or adjust the amount of tension in the composite material as it is unwound from the roll.

Each material guide assembly 30 includes a pair of upstanding roller mounts 40, 42 that are secured to the unwind frame 24. Each material guide assembly 30 further includes a first roller 44 interposed between, and rotatably coupled to, the upstanding roller mounts 40, 42, and a second roller 46 interposed between and also rotatably coupled to the upstanding roller mounts. The first roller 44 and the second roller 46 cooperate to define a nip indicated at 48 between them through which composite material being fed from the associated support roller assembly 28 passes. The first roller 44 may be vertically slidable relative to the upstanding roller mounts 40, 42 by an adjustment mechanism 50 that serves to vary and/or adjust the pressure on composite material 36a in the nip and/or the tension in the composite material 36a, etc. and/or the rate at which the composite material is drawn from the associated support roll assembly 28. The adjustment mechanism 50 can take the form of a pneumatic or hydraulic cylinder, a ball screw, a stepper motor or other mechanical actuator. However, the invention is not limited in this regard as numerous other adjustment mechanisms that would be known to one of ordinary skill in the art to which the invention pertains may be employed. The material guide assembly 30 serves to orient and direct the composite material 36a, etc. being drawn from the associated support roller assembly 28.

Each material guide assembly 30 may comprise a brake mechanism (not shown) and/or a drive mechanism (not shown). The brake mechanism would impart resistance to the rotation of the first roller 44, so that a desired tension can be maintained in the composite material 36a as it is pulled through the nip indicated at 48. On the other hand, a material guide drive mechanism may drive the first roller 44 to facilitate passage of the composite material 36a through the nip indicated at 48. In this way, the adjustment mechanism 50 may alleviate resistance to the advancement of the composite material 36a through the nip indicated at 48. Since the rotational inertia of a roll of composite material 36a on a support roller 32 varies as material is drawn from the roll, the adjustment mechanism 50 may be adjusted during operation of the apparatus 10 to maintain an appropriate tension in the composite material 36a.

The five roll support assemblies 26 are positioned on the unwind frame 24 so that when lengths of composite material 36a, etc., are drawn from each roll, the lengths will pass through a web aperture 52 in the unwind frame 24 and emerge from beneath the unwind frame 24 in side-by-side arrangement to define a web 54 that spans a width W, as shown in FIG. 4, defined by the number of rolls of composite material, the width W being wider than any one of the rolls of composite material, according to embodiments. As will be explained in detail below, the web 54 can provide at least a lengthwise first layer for a composite laminate.

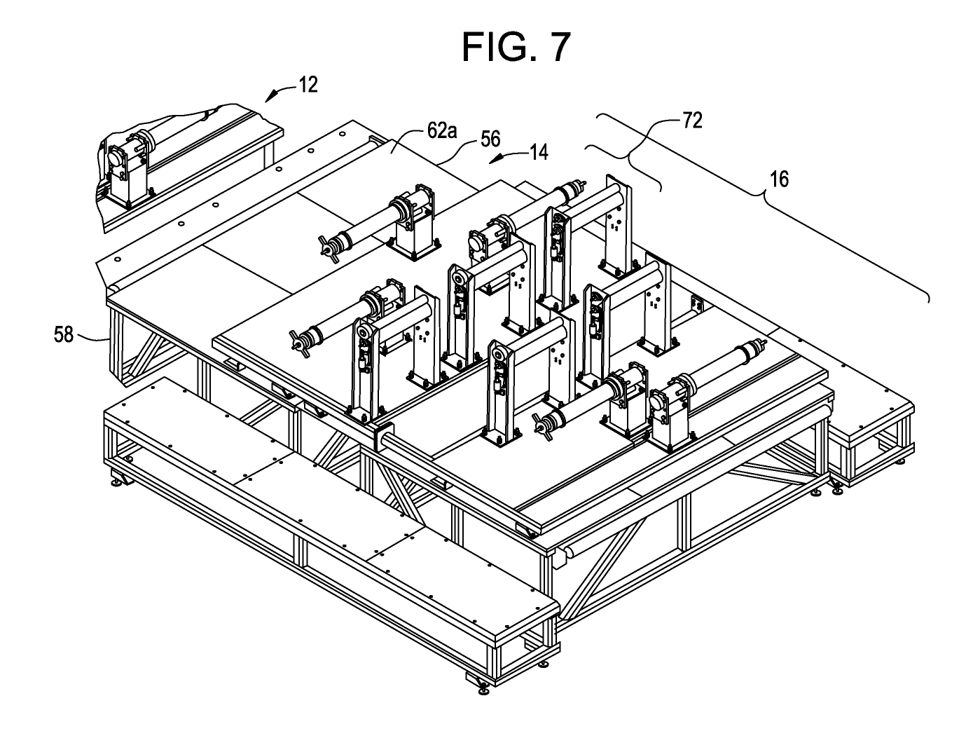

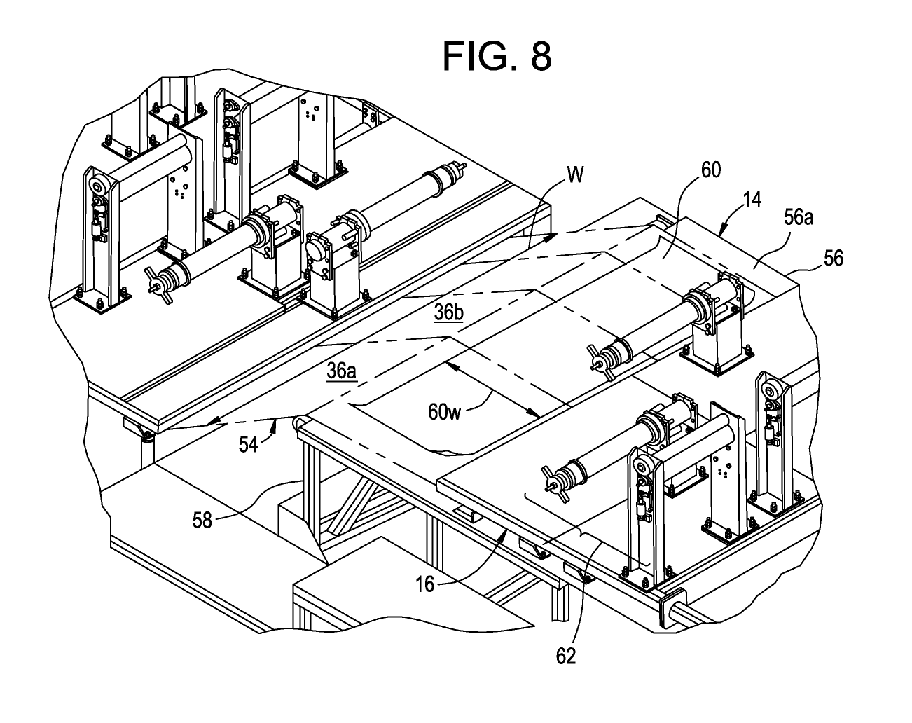

As shown in FIG. 7, the tacking station 14 is located downstream from the unwind station 12 and includes a tacking platform 56 mounted on a tacking frame 58. The tacking frame 58 can define a width that is approximately equivalent to the width of the unwind frame 24 (FIGS. 6 and 8). As shown in FIG. 8, the tacking platform 56 defines a substantially planar tacking surface 56a on which adjacent lengths of composite material 36a, 36b, etc., from the tacking station 12 are disposed and tacked together to form a first layer of the composite material, e.g., by disposing a second layer of composite material onto the first layer of composite material 36a, 36b, etc. Depending on the type of composite material 36a, etc. and the fiber orientation therein, the second layer of composite material can be tacked either lengthwise or in a cross ply or other configuration.

In one embodiment depicted in FIG. 8, the composite material 36a, 36b, etc., is tacked together by laying a cross ply 60 of composite material onto the composite material 36a, 36b, etc. The cross ply 60 overlaps at least two adjacent composite materials 36a, 36b and preferably extends across the entire width of the web 54. The cross ply 60 is tacked onto the composite material 36a, 36b, etc. to form a composite laminate. Tacking may be accomplished using heat guns, ultrasonic welding tools, adhesives, or the like, while the web 54 is moving through the apparatus 10. Tacking is a relatively quick and easy way of securing adjacent and/or layered sheets of composite material in the desired position for being bonded together.

The cross ply 60 may be a unidirectional sheet, i.e., the fibers therein may be mutually aligned. In a particular embodiment, the fibers in the cross ply 60 are disposed in transverse relation to the fibers in the composite material 36a in which case the cross ply 60 may be referred to as a cross-ply sheet and the resulting composite laminate may be referred to as a cross-ply laminate. The cross ply sheet may be disposed at any angle relative to the fibers in the composite material 36a, 36b, etc.

A cross ply 60 can have a width 60w in the process direction, as shown in FIG. 8. In one embodiment, a plurality of cross plies 60 are disposed in adjacent relation to each other on the layers of the composite material 36a, 36b, etc., to provide a consistent second ply for a composite laminate.

In one embodiment, an industrial robot may be employed to place cross plies 60 on the composite material 36a, 36b, etc. and, optionally, to tack the cross plies 60 thereon. Such a robot may be provided with a supply of cross ply material, e.g., in roll form or as a stack of pre-cut sheets. The robot may be equipped to place the cross ply material onto the web 54, e.g., by drawing a length of the cross ply material from the supply roll and cutting the cross ply material to the desired length by unwinding the web 54, or by handling a pre-cut sheet. The robot may be equipped with a tacking arm that includes a heat gun, sonic welding horn, or any other suitable tacking device, and that may tack the cross ply material to the web 54 and tack the composite material 36a, 36b, etc., together. The robot may be configured to draw or place the cross ply material orthogonally across the web 54 or at any other desired angle.

The optional second unwind station 16 is positioned downstream from, and above, the tacking station 14, as shown for example, in FIG. 8, and includes roll support assemblies 62 where additional rolls of composite material may be disposed. The second unwind station 16 has generally the same configuration as the first unwind station 12 to enable the second unwind station 16 to provide a web of composite material that spans a width approximately equal to width W, i.e., the second unwind station 16 has roll support assemblies 62 positioned to correspond to the positions of the roll support assemblies 26 of the first unwind station 12, according to embodiments. The second unwind station 16 is configured to permit the web 54 to pass beneath it and to allow an additional lengthwise layer of composite material from the second unwind station 16 to be added onto the web 54 of cross ply 60. In this way, the second unwind station 16 facilitates providing a second lengthwise layer of composite material for the composite laminate 200. While a second unwind station 16 has been shown and described for the apparatus 10, the present invention is not limited in this regard, and in other embodiments, an apparatus for making composite laminate may not have a second unwind station. In still other embodiments, an apparatus for making composite laminate may include more than two unwind stations, to enable the apparatus to produce a composite laminate having more than two lengthwise layers of composite material.

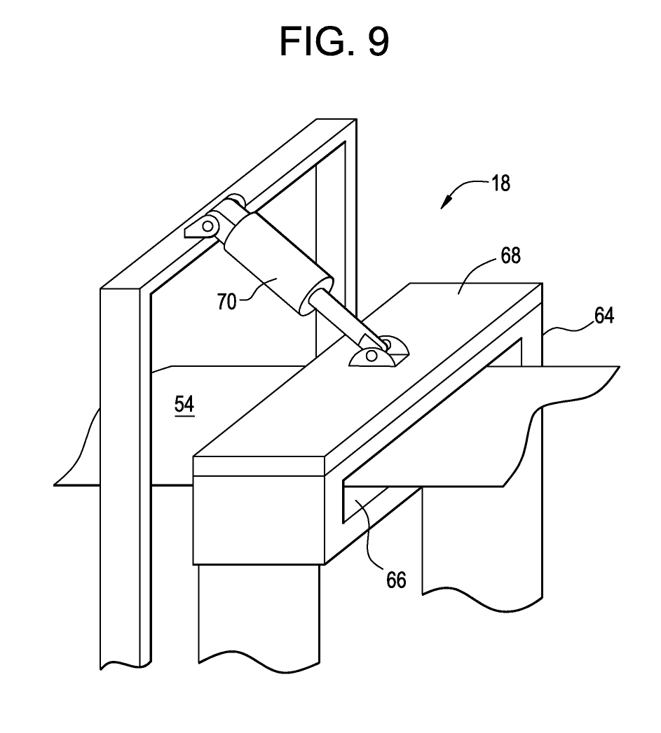

As shown in FIG. 9, one embodiment of a heating station 18 includes an oven 64 that has an entrance (not shown) that is adapted to receive the web 54 of cross ply 60, and an exit 66 to allow the web 54 of cross ply 60 to move through the oven. The oven 64, which may include a convection oven and/or any other suitable heating element such as an electric radiant heating element, an infrared heating element, electric heaters, hot oil heaters, air impingement heaters, combinations thereof, and the like for heating the web. The oven 64 has a cover 68 that is movable between a raised position and a lowered position via an actuator 70 such as, but not limited to, a hydraulic or pneumatic cylinder, a lead screw, a motor and the like.

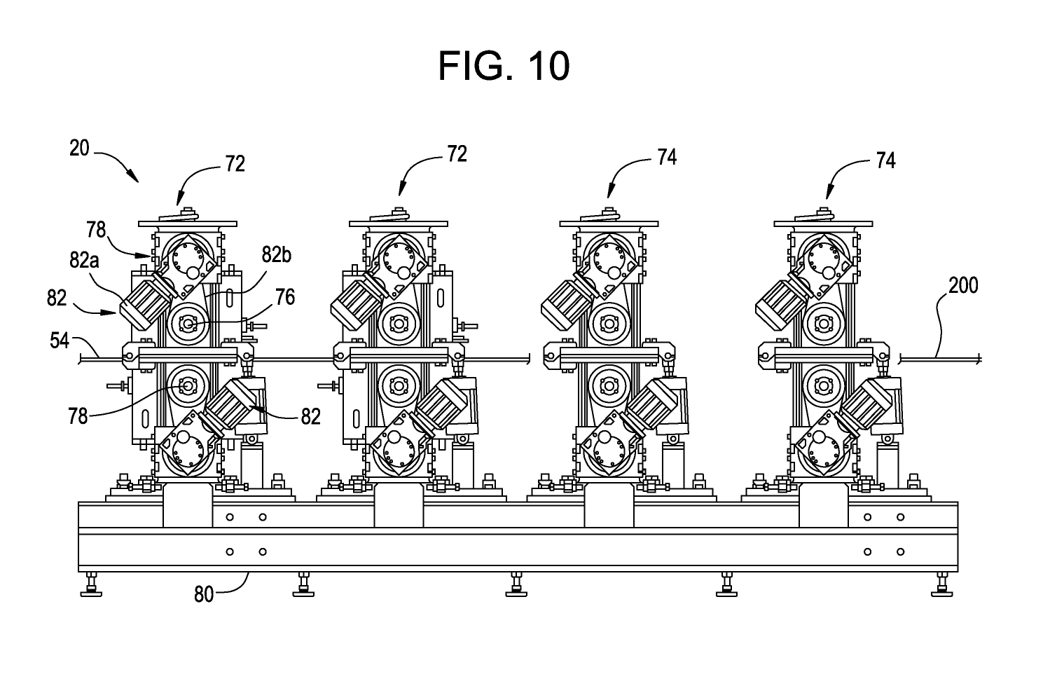

The processing station 20 is located downstream from the heating station 18. In one embodiment, as seen in FIGS. 10, 11 and 12, the processing station 20 comprises calendar roll assemblies 72 and 74. Each calender roll assembly 72, 74 includes a frame 80 which supports two calender rolls 76 and 78. A drive mechanism 82 for each roll includes a drive motor 82a that is coupled to the calender roll 76 or 78 via a drive belt 82b. While a belt drive has been shown and described, embodiments are not limited in this regard as other types of drives, such as a direct drive, or motor and gear reducer combination can be utilized. One or both of the calender rolls 76 and 78 in a calender roll assembly 72, 74 may be equipped with a rotary union that permits the flow of a thermal transfer fluid (e.g., oil or water) through the roll, to heat or cool the roll during use, as desired.

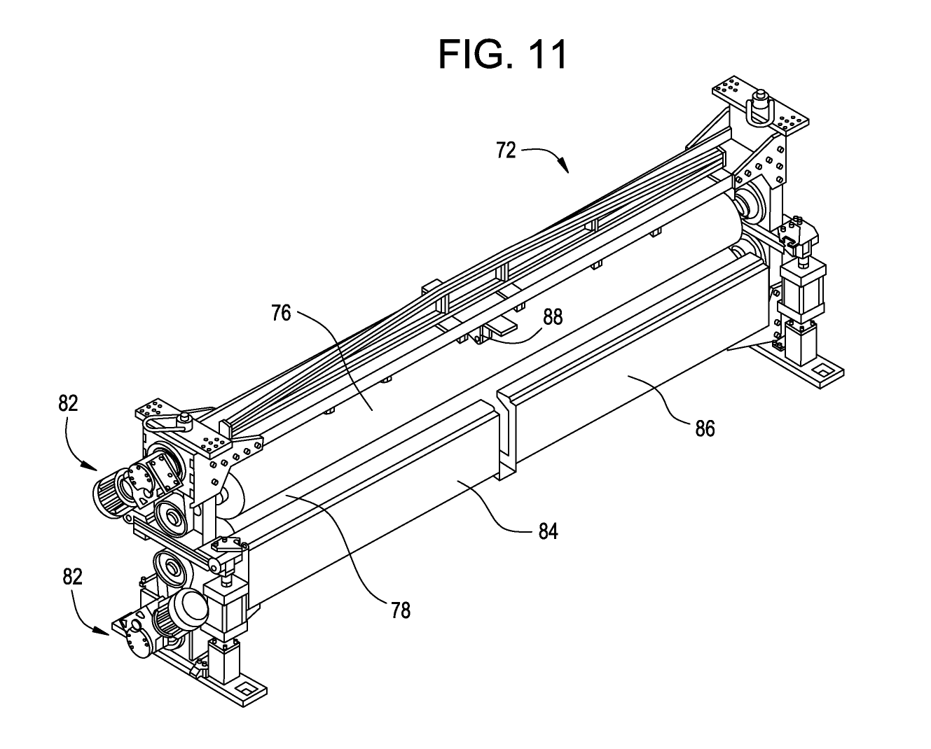

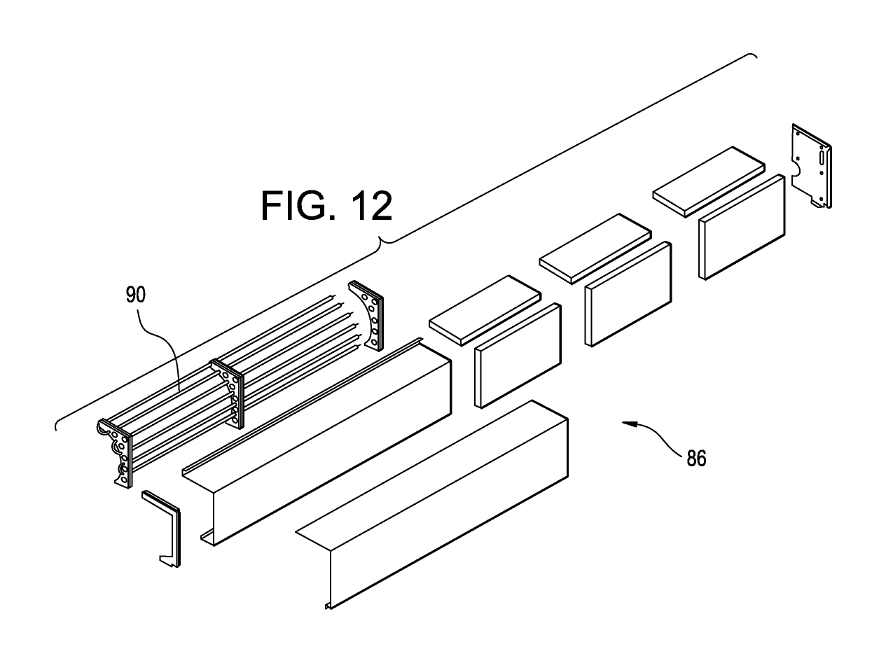

As best seen in FIG. 11, a heated calender roll assembly 72 comprises calender rolls 76 and 78 which cooperate to define a nip therebetween, and two roll ovens, 84 and 86, for the heating calender roll 78. Roll oven 84 heats a portion of the calender roll 78 and the second roll oven 86 is provided so that the calender roll is heated over its entire length, however, embodiments are not limited in this regard, for example, a single roll oven may heat the entire length of a calender roll, or only a selected portion of a calender roll may be heated. The calender roll assembly 72 includes a support follower 88 mounted and supported on calender roll assembly 72 so that it bears centrally on calender roll 76. Likewise, a support follower (not shown) is mounted to bear centrally on calender roll 78. The support followers 88 inhibit the calendar rollers from bowing away from each other in a central region. As shown in FIG. 12, the roll oven 86 comprises an electric radiant heating element 90 that is configured to conform to the curvature of the calender roll 78. As further shown in FIG. 11, the roll oven 84 is configured similarly to the roll oven 86. Alternatively, or in addition, one or both of the calender rolls 76 and 78 may be hollow and may define a flow path for the ingress and egress of a thermal transfer fluid therethrough, the thermal transfer fluid being supplied and withdrawn to and from a fluid supply. The roll 76 and/or the roll 78 may be equipped with a rotary union coupled to the roll through which hot thermal transfer fluid is flowed through the roll to provide heat.

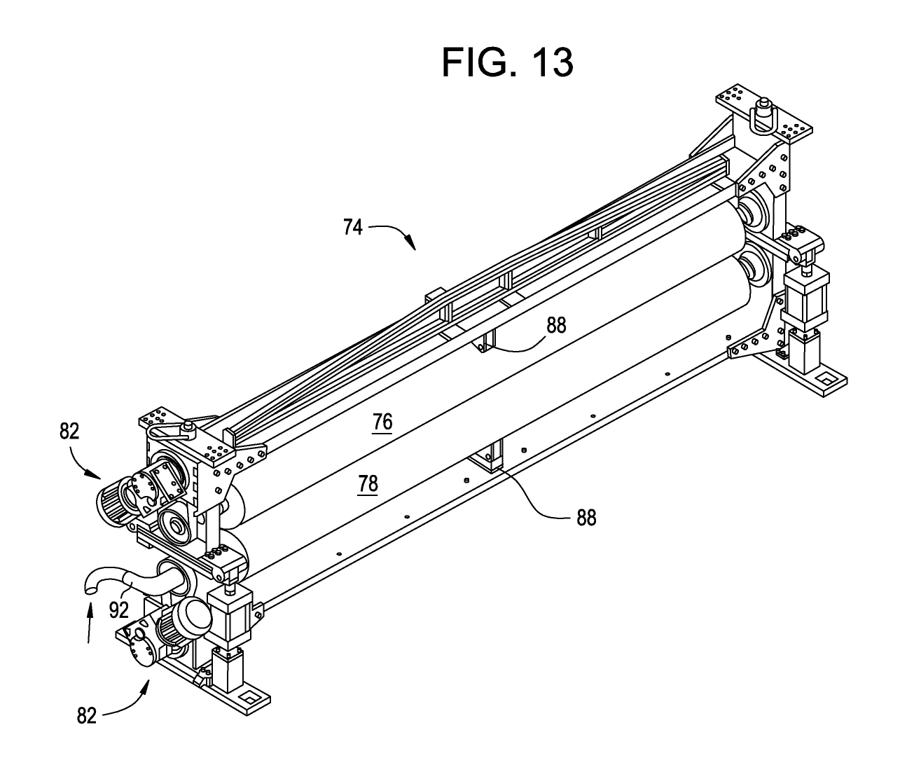

FIG. 13 provides a perspective view of an unheated calender roll assembly 74, which is configured similarly to calender roll assembly 72, except for the omission of the roll ovens 84 and 86. In the absence of roll oven 84 and roll oven 86, it can be seen that the calender roll assembly 74 includes two support followers 88 to bear centrally on the calender rolls 76, 78, as in calender roll assembly 72. The calender roll 78 is hollow and defines a flow path for the ingress and egress of a thermal transfer fluid therethrough, the thermal transfer fluid being supplied and withdrawn to and from a fluid supply. In the illustrated embodiment, the roll 78 is equipped with a rotary union 92 coupled to the roll and through which a thermal transfer fluid is flowed through the roll to draw heat from the web 54 in contact therewith. If necessary, the rotary union 92 can be used to provide a heating fluid to heat the calender roll 78.

The processing station 20 is shown in FIG. 10 as having four calender roll assemblies 72 and 74, however, embodiments are not limited in this regard, for example, a processing station 20 may include more than four or fewer than four calender roll assemblies, and may or may not have a cooling calender roll assembly and/or a heated calender roll assembly. For example, in one embodiment, rather than providing a cooled calender roll assembly, it may be sufficient to cool the web 54 by using a fan to blow cool air onto the web before the web passes to the uptake station 22, and/or by providing one or more unheated calender roll assemblies following the heated calender roll assembly 72, with the unheated calender roll assembly being spaced from the heated calender roll assembly 72 by a distance sufficient to allow heat to dissipate from the web 54 into the ambient air.

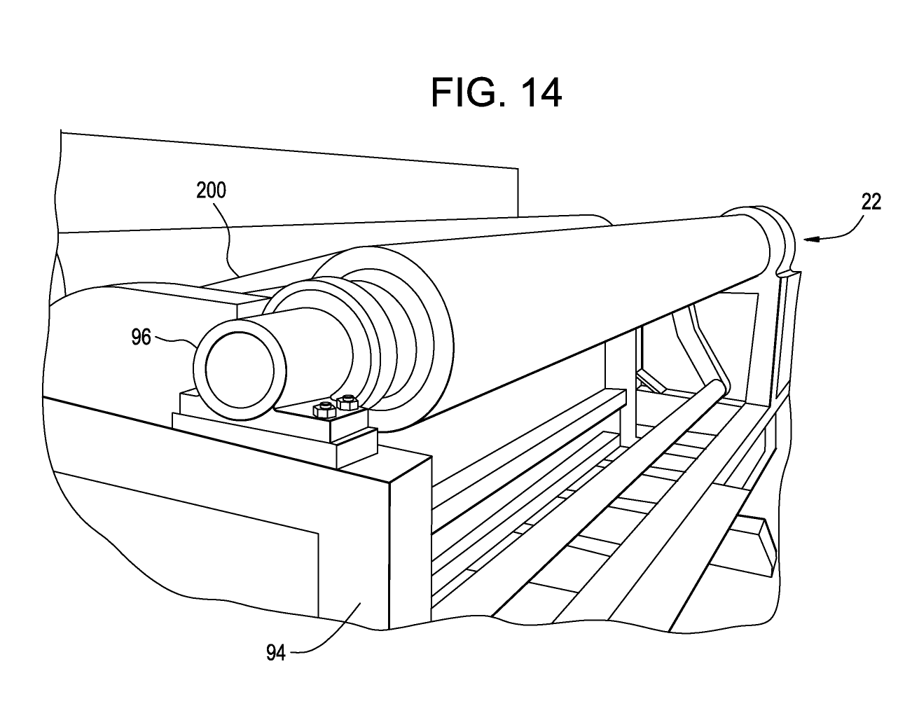

As shown in FIG. 14, the uptake station 22 comprises an uptake roll 96 positioned on an uptake frame 94. The uptake station 22 includes a motorized drive (not shown) for the uptake roll 96, to maintain an appropriate tension in the web 54. The motorized drive for the uptake roll 96 allows the uptake roll to collect the composite laminate finished product from the processing station 20.

It is further noted that the various parts of the above-described apparatus 10 generally depicted in FIG. 3 can be re-arranged as desired from the layout shown therein, for example, to change the sequence in which material encounters the various stations, to omit stations that are not needed for a particular process, or to add additional stations between the unwind station 12 and the uptake station 22. In addition, the components of the various stations are movable and can be re-arranged within their respective stations. For example, one or more roll support assemblies 26 may be added to, or removed from, the unwind station 12, as desired. In addition, the roll support assemblies 26 may be re-arranged on the unwind frame 24 to provide varying degrees of overlap from adjacent composite material 36a, 36b, etc., in the web 54 and/or to provide a web 54 of various desired widths. Likewise, the calender roll assemblies 72, 74 of the processing station 20 are movable on, and removable from, the calender roll frame 80. Accordingly, the number, type, sequence and/or spacing of calender roll assemblies in the processing station 20 can be changed to accommodate the characteristics desired in the composite laminate product. For one product or process, a single calender roll assembly 72 or 74 might be sufficient; for another, three or four calender roll assemblies (or more) may be employed. In addition, the calender roll assemblies 72, 74 may be rearranged to provide any desired sequence of heated calender roll assemblies and cooling calender roll assemblies: heat, then cool; cool, heat, then cool; heat, cool, heat again; heat, cool, heat again, then cool; etc. Such flexibility in the apparatus allows for flexibility in the process employed to make various products.

Embodiments disclosed herein also may include a process controller (not shown) that communicates with the principal control mechanisms of the apparatus (e.g., apparatus 12 shown in FIG. 4). In this way, the process controller provides a centralized point where an operator can control one or more aspects and the parameters of the operation, such as the speed of the web 54 through the apparatus 12, the tension in the web, the pressure applied at various nips, the temperature of the heating station 18, the amount of heat supplied by heated calender roll assemblies 72, the operation of the industrial robot for applying the cross ply and/or tacking the web 54, and processing parameters. Additionally, while not shown it should be appreciated that it is within embodiments disclosed herein to measure and/or monitor with suitable devices (e.g., sensors, visual displays) for, e.g., testing one or more of the aspects and/or parameters associated with the apparatuses and methods disclosed herein.

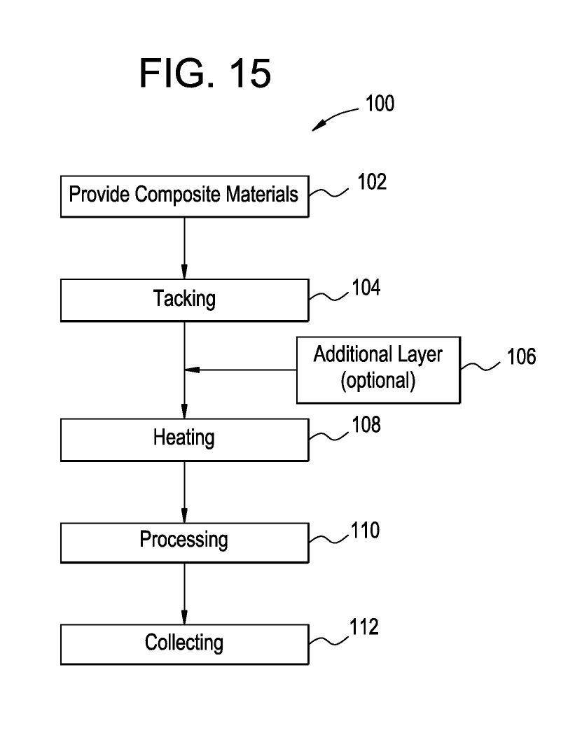

In one embodiment, the apparatus 10 of FIG. 3 can be used in conjunction with the processing steps set forth in FIG. 15 for making a composite laminate, e.g., composite laminate 200. The steps set forth in FIG. 15, generally denoted by reference numeral 100, begin with a first step 102 of providing lengths of composite material, e.g., from rolls of composite material 36a, 36b, etc., mounted on the roll support assemblies 26 of the unwind station 12. The lengths of composite material 36a etc. are drawn and arranged into a web 54 that extends to the tacking station 14. In a tacking step 104, the composite material 36a etc. is tacked together at the tacking station 14 to form the web 54, for example, with the use of the cross ply 60.

In an optional layering step 106, additional lengths of composite material may be added to the web 54. For example, additional rolls composite material may be disposed on the second unwind station 16 and the additional composite material may be unwound from the second unwind station 16 and applied onto the first ply composite material 36a, etc., and onto the cross ply 60. In this case, the method 100 can yield a composite laminate (FIG. 14) which includes two continuous plies (one each from unwind stations 12 and 16) with a cross-ply 60 between them.

After the tacking step 104, and after optionally applying additional layers of composite material on the web 54 in step 106, the web 54 is subjected to a heating step 108 to help the lengths of composite material 36a, etc., and any cross ply 60 thereon to bond together. For this purpose, the web 54 passes to the heating station 18, where the adjacent first ply composite material 36a etc. are heated to soften the polymeric material therein so that the various sheets can be bonded to one another. After the heating step 108, the web 54 is subjected to a processing step 110 in which the lengths of composite material 36a etc., are formed into a composite laminate that can be collected. For example, in one processing step 110, the web 54 passes to the processing station 20, where the material is subjected to pressure and, optionally, heating and/or cooling in one or more calender roll assemblies 72 and/or 74. The heat and/or pressure of the calender roll assemblies 72 and/or 74 causes the adjacent composite material 36a, 36b, etc. (and any other composite materials thereon) to bond together. When adjacent composite material 36a, 36b, etc., comprise thermoplastic matrix materials, the heat and/or pressure of the calender roll assemblies 72 and/or 74 may be sufficient to cause the materials to combine. However, if one or both of the adjacent composite materials comprise thermosetting matrix materials, it may be desirable to provide adhesive or other additional means as are known to one of ordinary skill in the art, to bond the composite materials together. The web 54 is cooled as part of the processing step 110, and in a collection step 112, the composite laminate product is collected at the uptake station 22 onto an uptake roll 96. The cooling that occurs in the processing step 110 permits the web 54 to collected, e.g., wound on a roll, as the composite laminate without bonding adjacent windings of the composite laminate onto each other.

In the embodiment of, e.g., FIGS. 3 and 10, the web 54 advances in the process direction through the heated calender roll assemblies 72 and then through the cooling calender roll assemblies 74. The heated calender roll assemblies 72 heat the composite materials so that adjacent composite materials bond together. Both calender roll assemblies 72 and 74 also compress the composite materials together to enhance the bonding process. The cooling calender roll assemblies 74 then remove heat from the web 54 so that adjacent layers of the composite laminate will not merge into each other at ambient temperatures. In this way, storage and handling of the composite laminate is facilitated. For example, a resultant composite laminate may be collected onto an uptake roll 96 at the uptake station 22 without bonding adjacent windings onto each other. It is further noted that by providing rolls of composite material 36a, etc., of sufficient length so that product sheet can be wound onto an uptake roll 96 as material is still being unwound from the unwind station 12, the process and apparatus described herein can be described as a “continuous” process.

Composite laminates described herein and produced with use of, e.g., the foregoing apparatuses and processes, can be used in a wide variety of end use applications, especially cargo handling container components and cargo carrier applications. In some embodiments, composite laminates are used as materials configured for use as liners, panels, flooring, containers and other structures in transportation applications, such as cargo carriers including trailers, and so forth. For example, such materials can be used to fabricate panels, liners, containers, flooring, wall coverings, and so forth, of various sizes and strengths. Different types of materials can be used alone or in combination with one another depending upon the desired application. Such articles as described herein provide stronger and more durable structures that can withstand the frequent impact of, e.g., fork lifts and other machinery during loading and unloading of cargo contents. By employing a thermoplastic matrix comprising polyethylene, alone or in combination with another material, in one or more ply of the composite laminates as described herein, such increase in strength and durability can be realized. Accordingly, an unmet need in the industry for such structures and components, particularly with regard to the transport of cargo and loading/unloading thereof, can be realized with embodiments described herein. Furthermore, such composite laminates are environmentally friendly, emit minimal vapor during processing, and are easy to handle, as well as clean.

More particularly, it has been determined that composite laminates described herein can be configured as resultant end use products including, but not limited to, panels, liners and containers, exhibiting advantageous properties in terms of, for example, improved puncture resistance at, e.g., lower weight, abrasion resistance, antimicrobial/antibacterial properties, stiffness, strength, UV resistance, and so forth.

Additionally, wider and longer composite laminates can be produced as a result of, e.g., the herein described processing and compositions of the individual plies used in the construction the laminates, according to embodiments. Examples of geometrical sizes for use as, e.g., cargo container liner components including, but not limited to, roofs and doors can range from about 86 inches up to about 125 inches in width. Finished product roll weights can range from about 2500 to about 10,000 pounds (lbs), for example, as supplied to a customer. Areal weight supplied in rolls can range from about 20 oz./sq. yd. up to about 80 oz./sq. yd., according to embodiments.

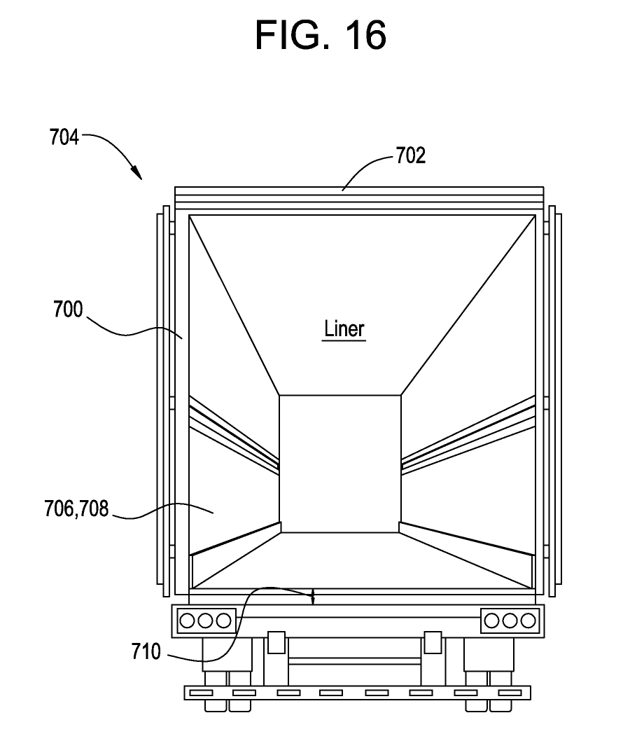

Non-limiting examples of particular end use products/applications for the composite laminates disclosed herein are set forth below. Referring to FIG. 16, the composite laminates disclosed herein can be used as, e.g., liners for interior portions of over the road trailers or other transportation vehicles, vessels, containers, and so forth. FIG. 16 illustrates a liner 700 in the interior portion 702 of an exemplary over the road trailer 704. The liner 700, according to embodiments, can provide a high-impact resistant composite panel exhibiting better properties than polypropylene reinforced thermoplastic products and standard chopped glass thermoset products. For example, liner 700 is lighter and more cleanable, more stain resistant, and more abrasion resistant than polypropylene based panels. Liner 700 can be located as an interior wall liner or wall covering, as well as a roof liner. Thus, liner 700 has applications for refrigerated containers (reefers), wall coverings, as well as other transport applications. Liner 700 can be configured as a durable, semi-rigid structure or panel specifically designed and formulated to improve thermal efficiencies in refrigerated containers such as reefers, according to embodiments. As also shown in FIG. 16, the composite laminates disclosed herein can be configured for use as a scuff panel. Specifically, FIG. 16 illustrates a scuff panel 706, which also is a high-impact, durable, semi-rigid panel that is more cleanable, stain resistant, and more abrasion resistant than, e.g., polypropylene panels. Scuff panel 706 are designed for the use as a scuff plate 708, as shown in FIG. 16, to protect the lower portion of sidewall panels for, e.g., refrigerated and dry van trailers and truck bodies. Scuff panel 706 can have a higher puncture resistance than the upper wall liner portions shown mounted above in FIG. 16, according to some embodiments.

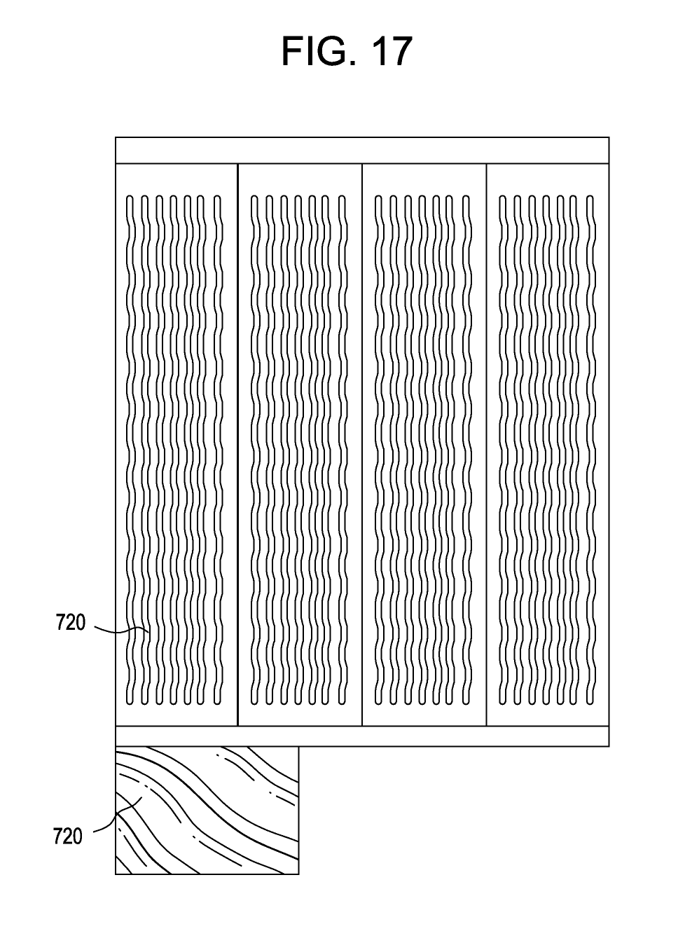

In accordance with further embodiments and end use applications, and as illustrated in FIGS. 16 and 17, the composite laminates disclosed herein can be configured as a corrugated panel 720 for a floor or subfloor of, e.g., a trailer or other vehicle, vessel, container and so forth. The corrugated panel 720 also can be covered with a coating, such as a durable flooring material also made from the composite materials and/or composite laminates disclosed herein, according to embodiments. More particularly, FIG. 17 shows corrugated side panel liners for rail cars using dry ice as the refrigerant, and the curved corrugated shape allows for the flow and movement of cooled air on the outside walls of the cargo device. The curvature can slow the flow rate of the cooled air.

Still further, and as shown in FIG. 18, the composite laminates disclosed herein can be configured as a non-corrugated panel 712 for a floor or subfloor of, e.g., a trailer or other vehicle or vessel. Similarly, non-corrugated panel 712 also could be covered with a coating, as described above, according to embodiments. More particularly, FIG. 18 shows individual inserts of liner material that can be inserted between structural posts of the trailer construction. Depending on the trailer and container manufacturing techniques employed, this configuration can be, e.g., an alternative interior liner to the continuous liner. It is further noted that this configuration may not be as typical an application as a full length liner.

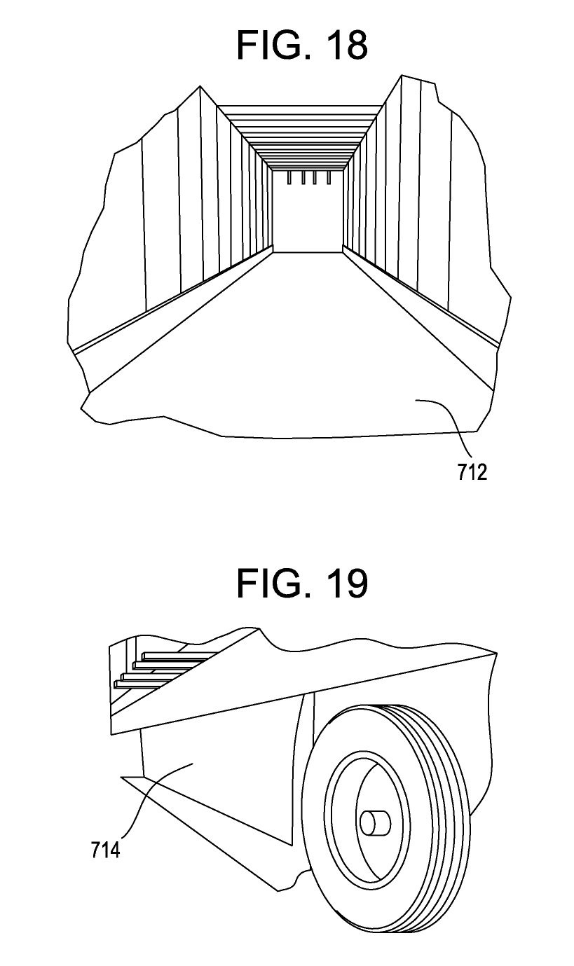

Further end use applications of the composite laminates disclosed herein include aerodynamic side skirts, such as the side skirt 714 illustrated in FIG. 19. According to embodiments, the side skirt 714 can comprise fiberglass reinforcing fibers in the thermoplastic matrix comprising polyethylene, among other fibers described herein. The side skirt 14 comprises a high impact, durable and semi-rigid panel exhibiting a high strength to weight ratio and also can have an expansion/contraction value comparable to aluminum.

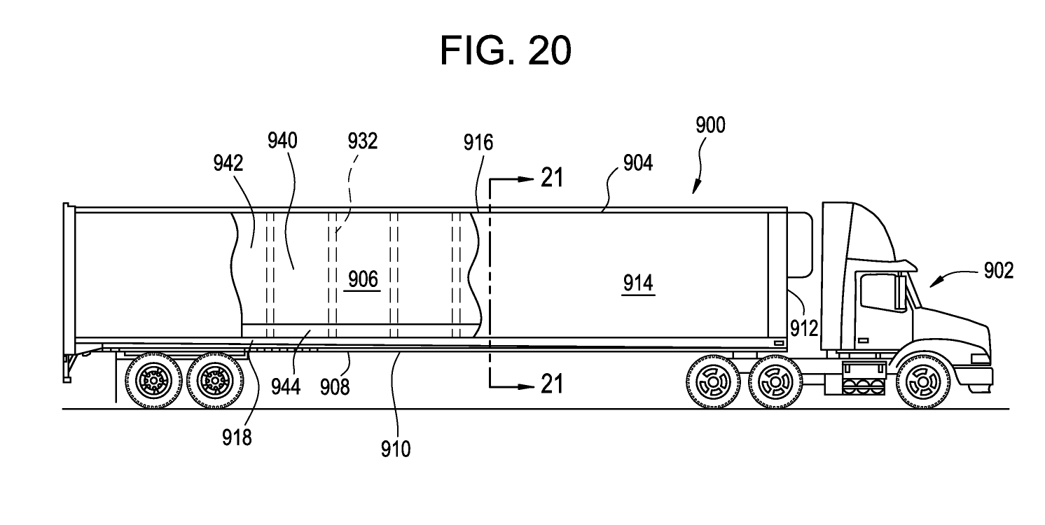

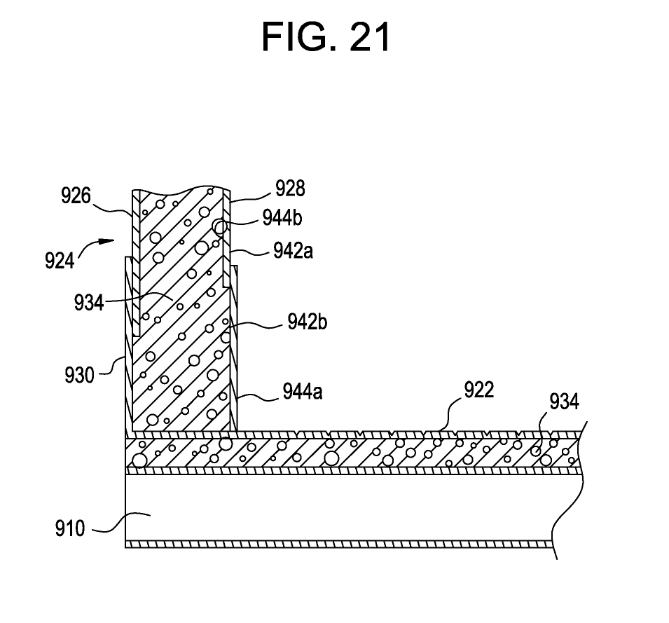

With further regard to over the road tractor trailer end use applications, reference is herein made to FIG. 20, which generally schematically depicts an over the road tractor trailer 900. A conventional tractor 902 can be hitched to the trailer 900 to pull, e.g., a refrigerated trailer 904. The trailor 904 can comprise an interior cargo carrying area or interior portion 906 and an undercarriage assembly 908 supporting a trailer bed 910, front wall 912, side walls 914, a rear door (not shown) and a roof 916. The trailor bed 910 can comprise a beam 918, as seen in FIG. 20. The side walls 914 can comprise a core 924 sandwiched between outer and inner side walls 926, 928. As can be seen in FIG. 21, the core 924 can be supported with use of a rail 930. It will be appreciated that other supporting mechanisms also can be employed. For example, as shown in FIG. 20, the refrigerated trailer 904 could include a plurality of upright supports 932, typically z-shaped in cross section and fabricated of aluminum or a non-thermally conductive material such as a fiberglass or polyester pultrusion to minimize heat transfer.

An insulation foam 934, such as a thermoset plastic foam including urethane foam, among others, can be formed between the outer and inner side walls 926, 928 and the supports 932. The outer and inner side walls 926, 928 and the supports 932 could be positioned in a fixture and the foam 934 then foamed in to complete the core 924. It is noted that the supports 932 could be optional for some trailer manufactures. In such a case the foam 934 could be relied upon for structural support and rigidity. Also, an aluminum extrusion structure 922, as shown in FIG. 21, can be filled with insulating foam 934.

It is further noted that the outer side wall 926 could be made of any suitable material, e.g., fiberglass, steel, stainless steel or aluminum, while at least a portion of the inner side wall 928 is fabricated of a thermoplastic composite liner 940, according to embodiments, and as described herein regarding the composite laminates described extensively herein.

It is noted that, depending on the requirements of the trailer manufacturer, the thermoplastic composite liner 940 could extend the entire interior length and height of the inner side wall 928 or a somewhat smaller area to account, for example, for portions of the side wall taken up by a front wall frame area at the front of the trailer 904 and rear frame area adjacent the rear of the trailer 904 that are not overlaid by the thermoplastic composite liner 940. The liner 940 can be affixed to the core 924 by adhesion between the foam 934 and the liner 940. For example, the foam 934 could adhere to an inner side of the thermoplastic composite liner 940 comprising a roughened or smooth surface with fibrous material embedded therein. A roughened surface is typically referred to a “scrim” or “scrim side”. The fibrous material may include polyester fibers, fiberglass mat or spun fiberglass materials, nylon fibers, PVC, crushed light bulb glass among others, for example, as described above regarding the fibers and reinforcements for the composite plies of the composite laminates described herein. The attachment is generally by metal fasteners, such as rivets, screws and other attachment means. For additional attachment strength, mastics, adhesives or PVC fasteners could be used around the edges of the thermoplastic composite liner 940.

In trailers, such as dry freight trailers, where no insulation foam is present, the side walls could comprises a plurality of supports 932 extending between the bottom rail 930 and a top rail (not shown) of the trailer. In such a construction, the thermoplastic composite liner 940 could be affixed to the supports 932 by mastics, adhesives or mechanical fasteners, such as metal or PVC rivets. Metal rivets and other metal fasteners may be used where heat transfer is not an issue and the nature of the cargo does not require a smooth inner wall surface.

The composite thermoplastic liner 940 can comprise, e.g., a rectangular thermoplastic composite sheet 942, among other suitable shapes and sizes. A thermoplastic composite scuff panel 944 could be integral therewith. Alternatively an aluminum scuff panel could be employed. However, the thermoplastic sheet 942 and scuff panel are preferably comprised of fiber-reinforced polymer (FRP) of a polyethylene resin reinforced with fiber, specifically glass fiber, as described extensively herein. The thermoplastic composite sheet 942 can be affixed or permanently bonded to the scuff panel 944 by, e.g., ultrasonic welding, heat bonding, and so forth. The ultrasonic welding, described below, can result in a linear weld joint extending at least part or all of the length of the scuff panel 944. The weld joint can provide a watertight and airtight seal between the thermoplastic composite sheet 942 and the scuff panel 944.

The scuff panel 944 could be thicker and narrower than the thermoplastic composite sheet 942. The thermoplastic composite sheet 942 and the scuff panel 944 function to, e.g., protect the interior portions from impact damage due to cargo, pallets, the forks of lift trucks, etc., while cargo is being moved into and out of the trailer 904. The scuff panel 944 can be positioned adjacent the trailer floor where greater damage from lift truck forks and pallet edges would be expected. In addition to the protecting function, the thermoplastic composite liner 940 functions as an additional layer of insulation in the refrigerated trailer 904. The thickness and width of the thermoplastic composite sheet 942 and the scuff panel 944 depend on the specific application, size of the trailer 904, type of trailer, etc. An example of a thickness range for the thermoplastic composite sheet 942 is a range of about 0.020-0.090 inches with a width of about 80-100 inches. An example of a thickness range for the scuff panel 944 is a range of about 0.100-0.250 inches with a width of about 12-48 inches. It is noted that other suitable thicknesses and widths are possible.

A desired length of the thermoplastic composite sheet 942 is cut from a roll and a desired length and the scuff panel 944 can be cut from another roll, in an embodiment. One side or face 942a of the sheet 942 can be smooth and the other side 942b can have a rougher, fibrous finish. The fibrous surface side 942b (scrim surface) can be provided by, e.g., the manufacturer of the thermoplastic composite sheet 942 to facilitate the foam 934 bonding to the thermoplastic composite sheet 942. Similarly, with regard to the thermoplastic scuff panel 944, one side 944a is smooth, while the opposite side 944b can have, e.g., a fibrous polyester finish. When the thermoplastic composite liner 940 is installed, the scrim sides 942b, 944b of the thermoplastic sheet 942 and the scuff panel 944 face the core 924 to facilitate bonding with the foam 934, while, e.g., the smooth sides 942a, 944a face the cargo area 906 to provide, e.g., a smooth, low friction finish.

It is further noted that the afore-referenced thermoplastic composite liner 940 described above with respect to FIGS. 20 and 21 can comprise the compositions and configurations of the various composite laminate embodiments described herein, and in any combinations.

It should be further recognized that the thermoplastic composite liner 940, as well as the composite laminates described herein in general, also are applicable to many types of cargo carriers, such as trailers, vans, delivery vehicles, rail cars, aircraft, ships, shipping containers used therein, and so forth. Additionally, it is the intent herein that the word “trailer” can include all such cargo carriers, and to use the words “shipping container” can thus include all shipping containers used therein.

Accordingly, in accordance with still further end use applications, while the composite laminates described herein have been described above, according to embodiments, as generally being configured as liners/panels for over the road trailer truck applications, other applications are within the scope of embodiments described herein, such as, e.g., interior liners/panels configured for rail cars, interior liners/panels configured for aircrafts, interior liners/panels for containers, such as intermodal containers, armor and ballistic applications such as fire resistant/retardant ballistic composite panels, and so forth. Moreover, structures such as the container itself, panel, and so forth also could be fabricated and/or refurbished using the composite materials and laminates disclosed herein.

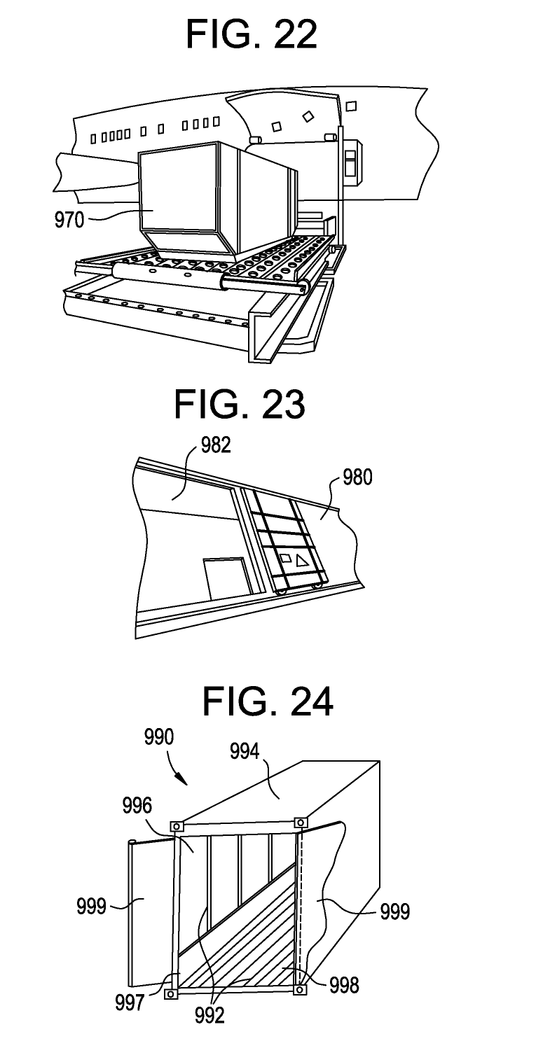

As a non-limiting example of the foregoing, FIG. 22 illustrates a perspective view of an air cargo container 970, which can include a thermoplastic composite liner, as described herein, on an inner portion of the container 970, according to embodiments. The container 970 also could be made from the liner material and/or used for refurbishment, as explained above.

In accordance with further end use applications, FIG. 23 is a perspective view of a rail car 980 including a thermoplastic composite liner 982, according to embodiments. As also explained above, the liners disclosed herein can be located at various locations of a container body. For example, in the embodiment of FIG. 23, liner 982 is located on the interior portion of a rail car wall.

FIG. 24 further illustrates a schematic perspective view of an intermodal container 990 including a thermoplastic composite liner 992, according to embodiments. The intermodal container 990 comprises a roof portion 994, interior side walls 996, a floor 998 and door portions 999. As shown therein and described extensively herein, the liners according to embodiments, can be located at various locations of, e.g., a container or other structures. For example, as shown in FIG. 24, liner 992 can be located on floor 998 as a covering or integral therewith. Liner 992 also can be located on at least a portion of interior side walls 996, as well as be located on the interior portion of the roof portion 994. FIG. 24 further illustrates a scuff panel 997, which also can be made of and/or coated with the liner 992 described herein. It is further noted that the intermodal container 990 can be moved from one mode of transportation to another, such as from rail to ship to truck and so forth without the need to reload and unload the contents of the container. The size of the container 990 meets standard ISO requirements, according to embodiments. For example, the length can vary from 8 feet to 50 feet, and the height can vary from 8 feet to 9 feet, 6 inches.

Moreover, as noted above, the embodiments disclosed herein are also applicable as armor or ballistic materials for, e.g., vehicles and personnel. For example, the embodiments disclosed herein can be used as fire retardant ballistic composites and panels wherein, e.g., the thermoplastic matrix material comprises PVDF. As non-limiting example, the structures shown in, e.g., FIGS. 1 and 1A could be employed as fire retardant composite ballistic panels. The ballistic materials and panels can be used to fabricate, e.g., fire retardant portable ballistic shields, such as a ballistic clipboard used by a police officer, to provide fire retardant ballistic protection for fixed structures such as control rooms or guard stations, and to provide fire retardant ballistic protection for the occupants of vehicles, and so forth.

It is further noted that ballistic materials including panels can be tested in accordance with standards that evaluate their ability to withstand ballistic impact. Such standards, which are described briefly below, have been established by, e.g., the Department of Justice's National Institute of Justice entitled “NIJ Standard for Ballistic Resistant Protective Materials (NIJ Standard”). As the ballistic threat posed by a bullet or other projectile depends, e.g., on its composition, shape, caliber, mass and impact velocity, the NIJ Standard has classified the protection afforded by different armor grades as follows: Type II-A (Lower Velocity 357 Magnum and 9 mm), Type II (Higher Velocity 357 Magnum and 9 mm); Type III-A (44 Magnum, Submachine Gun and 9 mm), Type III (High-Powered Rifle), and Type IV (Armor-Piercing Rifle).

More particularly, Type II-A (Lower Velocity 357 Magnum and 9 mm): Armor classified as Type II-A protects against a standard test round in the form of a 357 Magnum jacketed soft point, with nominal masses of 10.2 g and measured velocities of 381+/−15 meters per second. Type II-A ballistic materials also protect against 9 mm full metal jacketed rounds with nominal masses of 8 g and measured velocities of 332+/−12 meters per second.

Type II (Higher Velocity 357 Magnum; 9 mm): This armor protects against projectiles akin to 357 Magnum jacketed soft point, with nominal masses of 10.2 g and measured velocities of 425+/−15 meters per second. Type II ballistic materials also protect against 9 mm full metal jacketed rounds with nominal masses of 8 g and measured velocities of 358+/−12 meters per second.

Type III-A (44 Magnum, Submachine Gun 9 mm): This armor provides protection against most handgun threats, as well as projectiles having characteristics similar 44 Magnum, lead semiwadcutter with gas checks, having nominal masses of 15.55 g and measured velocities of 426+/−15 meters per second. Type III-A ballistic material also protects against 9 mm submachine gun rounds. These bullets are 9 mm full metal jacketed with nominal masses of 8 g and measured velocities of 426+/−15 meters per second.

Type III (High Powered Rifle): This armor protects against 7.62 mm (308 Winchester®) ammunition and most handgun threats.

Type IV (Armor-Piercing Rifle): This armor protects against 30 caliber armor piercing rounds with nominal masses of 10.8 g and measured velocities of 868+/−15 meters per second.

In furtherance to the above, other tests for ballistic materials include the V₅₀ test as defined by MIL-STD-622, V₅₀ Ballistic Test for Armor. U.S. Pat. No. 7,598,185 further describes this test, and the contents of this patent are hereby incorporated by reference. For example, the V₅₀ Ballistic Test may be defined as the average of an equal number of highest partial penetration velocities and the lowest complete penetration velocities which occur within a specified velocity spread. A 0.020 inch (0.51 mm) thick 2024-T3 sheet of aluminum is placed 6±½ inches (152±12.7 mm) behind and parallel to the target to witness complete penetrations. Normally at least two partial and two complete penetration velocities are used to compute the V₅₀ value. Four, six, and ten-round ballistic limits are frequently used. The maximum allowable velocity span is dependent on the armor material and test conditions. Maximum velocity spans of 60, 90, 100, and 125 feet per second (ft/s) (18, 27, 30, and 38 m/s) are frequently used.

Advantageously, embodiments disclosed herein including fire retardant ballistic panels described herein may achieve at least one of the protection levels against a projectile as defined by the afore-referenced NIJ Standard Armor grades II-A, II, III-A, III and IV when the projectile is directed at the panel, as well as may pass the afore-referenced V₅₀ test.

### EXAMPLES

Testing was conducted on sample liners employing a thermoplastic composite matrix comprising polyethylene in comparison to polypropylene liners. The resulting data, as described in further detail below, demonstrates that with embodiments herein, improved cold temperature properties in terms of, e.g., strength, puncture resistance, elongation, overall puncture strength, and lubricity for deflection and sliding off of objects that impact the liner can be achieved.

More particularly, puncture shear testing was conducted on sample liners of various layer configurations and compositions. The puncture shear testing was conducted by standard techniques in which a plunging test tool having a 0.5 inch radius was employed in a universal tester at varying pounds of applied force against the samples, which were generally of the same sample size.

It has been determined that, as a guideline, a liner for, e.g., an interior liner of a refrigerated trailer should be able to withstand between about 400 pounds to 500 pounds of force without puncturing, based on a puncture shear test using the afore-referenced plunging test tool. A target for the testing was to withstand 500 pounds of force based on a twelve sample average eliminating the high and low values (10 sample average). Tables 1 and 2 below set forth results for comparative liner samples having a polypropylene thermoplastic matrix.

TABLE 1

| Type: WP Puncture | | Specification |
|---|---|---|
| Trials (Pounds of Force | Multiply | Target |
| (lbs.) | (lbs.) | (lbs.) |
| Sample A (7034X) | 338 | 350 |
| Sample B (7034Q) | 384 | 500 |

*Average based on 10 Samples each of A and B; Sample A in a Cross (X) ply and Sample B is a Quad Ply both made from the same 7034 tape

TABLE 2

| Type: FH Puncture | | Specification |
|---|---|---|
| Trials (Pounds of Force | Multiply | Target |
| (lbs.) | (lbs.) | (lbs.) |
| Sample C (7034X) | 434 | 350 |
| Sample D (7034Q) | 555 | 500 |

*Average based on 10 Samples each of C and D; Sample C is a Cross (X) ply and Sample D is a Quad ply made from the same 7034 tape

As can be seen from the data set forth above in Tables 1 and 2, Samples C and D exceeded the targets, while Samples A and B were below the targets. As can also be seen from the above Tables 1 and 2, Sample A performed better than Sample C and Sample B performed better than Sample D. It is further noted that these comparative polypropylene samples had essentially the same melt flow index (MFI) and mechanical properties.

Referring now to Table 3 below, set forth therein are the puncture resistance results of various samples (Samples 1-11) and corresponding properties of the samples. It is noted that Samples 5, 6, 8, 10 and 11 include polyethylene in the thermoplastic matrix, according to embodiments, and Samples 1-4, 7 and 9 are comparative polypropylene samples It is further noted that F/S denotes the addition of a polypropylene cosmetic surface film. The polypropylene film ranges in thickness between 0.004 inches and 0.010 inches, and the test data is based on a 0.004 inch thick film on one side and a veil or scrim on the other side that can be used to bond the liner to insulation foam of a refrigerated trailer wall panel. The veil composition is polyester or glass and is based on areal weight, and the test materials employ a 2 oz./sq. yd. areal weight.

Regarding the particular compositions and layer configuration of each sample, the IE 7024Q samples are quad ply (4 ply 0/90/90/0 layup, 70% glass fiber by weight) and the IE 6527T samples are triply (0 to 90 to 0 orientation layup, 65% glass fiber by weight).

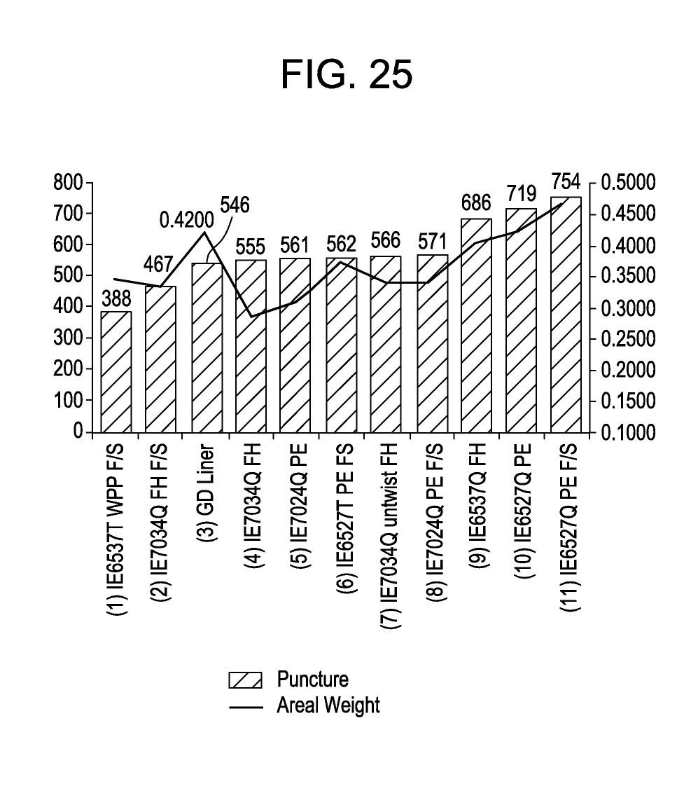

The results of the Table 3 are plotted in the bar graph set forth in FIG. 25. Referring to, for example, the data for Samples 5 and 6, according to embodiments, and plotted in FIG. 25, it is noted that these samples are near the same square foot weights as the samples set forth in Tables 1 and 2 (polypropylene), but exhibit better puncture resistance results. It is further noted that the areal weight for 7034X samples (Samples A and C) is 0.146 lbs./sq. ft. and the areal weight for 7034Q samples (Samples B and D) is 0.292 lbs./sq. ft.

Moreover, it can be further seen from FIG. 25 that at least two configurations (e.g., IE 7024Q and IE6527), according to embodiments, exhibited improved puncture resistance performance over the comparative samples. As further evident from FIG. 25, Sample 11 exhibited the best overall puncture resistance results (754 pounds of force). FIG. 25 further demonstrates that, e.g., two comparative polypropylene samples with essentially the same melt flow index (MFI) and mechanical properties from two difference sources may not necessarily result in the same puncture strength.

It is noted that the FH polypropylene can be significantly higher in price than the polyethylene employed according to embodiments, and/or the WP polypropylene (e.g., varying between about 24% to 49% depending upon when purchased). It is further noted that polypropylene is typically very volatile in its price variation, and could exhibit a price variation of about 50% throughout a given year. In contrast, polyethylene is more stable in pricing and may vary only about 10 to 20% in a given year.

TABLE 3

| | | | | | Areal | |
|---|---|---|---|---|---|---|
| | | | | Puncture | Weight | Thickness |
| Sample No. | Sample | Plastic Type | Film/Scrim | (lbs.) | (lb./ft²) | (inches) |
| 1 | IE6537T | WP | Yes | 388 | 0.3449 | 0.050 |
| | WPP F/S | | | | | |
| 2 | IE7034Q | FH | Yes | 467 | 0.3331 | 0.053 |
| | FH F/S | | | | | |
| 3 | GD Liner | N/A | Yes | 546 | 0.4200 | 0.072 |
| 4 | IE7034Q | FH | No | 555 | 0.2828 | 0.038 |
| | FH | | | | | |
| 5 | IE7024Q | PE | No | 561 | 0.3074 | 0.039 |
| | PE | | | | | |
| 6 | IE6527T | PE | Yes | 562 | 0.3716 | 0.056 |
| | PE FS | | | | | |
| 7 | IE7034Q | FH | Yes | 566 | 0.3387 | 0.053 |
| | untwist FH | | | | | |
| 8 | IE7024Q | PE | Yes | 571 | 0.3471 | 0.049 |
| | PE F/S | | | | | |
| 9 | IE6537Q | FH | No | 686 | 0.4053 | 0.058 |
| | FH | | | | | |
| 10 | IE6527Q | PE | No | 719 | 0.4248 | 0.058 |
| | PE | | | | | |
| 11 | IE6527Q | PE | Yes | 754 | 0.4686 | 0.065 |
| | PE F/S | | | | | |

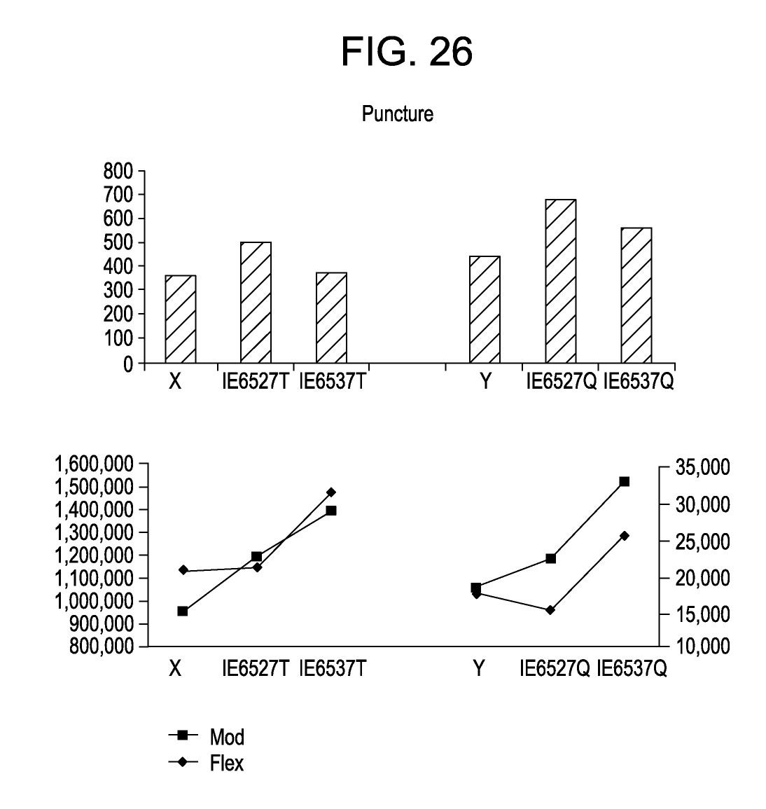

Table 4 below and FIG. 26 set forth further puncture resistance testing results. In particular, comparative Samples Y and Z were tested against samples in accordance with embodiments (IE6527T, IE65637T, IE6527Q and IE6537Q) as noted in Table 4 and FIG. 26. Comparative Samples Y and Z are generally 55 weight % glass. It is noted that puncture is the primary property for performance evaluation. However, modulus and strength are also considered. Another parameter to consider is the stiffness or K rate, which can be important to stiffness (EI) between, e.g., the structural posts of a trailer. If the value is to low then the interior wall can deflect between structural posts and not be able to withstand slide loading that can occur during transport. It is noted that K rate is also a function of stiffness. As can be seen from FIG. 26 and Table 4, in comparison to Sample Y, both 6537T and 6527T perform well against Sample Y and are approximately 15% less in thickness and slightly less in weight. Moreover, both 6537T and 6527T performed significantly better in terms of puncture resistance, which is the primary performance criteria.

TABLE 4

| | | | 0° | 90° | | | | |
|---|---|---|---|---|---|---|---|---|
| | | Areal | Bend | Bend | 0° | 90° | | |
| | Thickness | Wt. | Str. | Str. | Modulus | Modulus | Puncture | K-Rate |
| Sample | (in.) | (lb./ft²) | (psi) | (psi) | (psi) | (psi) | (lbs.) | (lb./in./in.) |
| X | 0.061 | 0.350 | 20,465 | 12,966 | 956,965 | 264,134 | 363 | 780.41 |
| IE6527T | 0.052 | 0.343 | 21,028 | 6,925 | 1,195,302 | 132,311 | 503 | 725.67 |
| IE6537T | 0.052 | 0.348 | 31,331 | 9,834 | 1,400,973 | 196,815 | 382 | 920.33 |
| Y | 0.085 | 0.514 | 17,899 | 16,816 | 1,068,804 | 501,184 | 454 | 1,363.43 |
| IE6527Q | 0.064 | 0.452 | 15,370 | 12,023 | 1,200,056 | 360,044 | 690 | 1,089.41 |
| IE6537Q | 0.070 | 0.460 | 25,606 | 15,026 | 1,537,218 | 340,043 | 574 | 1,533.08 |

Accordingly, in view of the foregoing detailed descriptions and data, it can be seen that as a result of, e.g., the formulations of the composite laminates and configurations described herein, particularly use of a fiber reinforced thermoplastic matrix comprising polyethylene in one or more of the composite plies of the composite laminates, superior material properties and characteristics of panels, liners and other structures made therefrom can be realized.

Moreover, as demonstrated above, the composites laminates, according to embodiments can advantageously be fabricated into liners, panels and/or other structural components, such as air cargo, rail and intermodal containers. Advantageously, such structures including panels can achieve puncture resistance levels of, e.g., greater than about 560 pound of force, specifically greater than about 570 pounds of force using the above testing standards. More particularly, as further advantageously demonstrated above, such structures can achieve puncture resistance levels of, e.g., greater than about 570 pounds of force, specifically greater than about 710 pounds of force and greater than about 750 pounds of force, according to embodiments. Thus, puncture resistance level ranges of, e.g., between about 560 to about 760 pounds of force, specifically between about 570 pounds of force and 760 pounds of force, more specifically between about 715 pounds of force and 760 pounds of force, may be achieved.

It will be appreciated that the liners and/or panels could be attached to structures, as also explained above, such as being attached to interior flooring, side walls, roofing, scuff plates, as well as other container portions. Similarly, entire or portions of, e.g., air cargo, rail and intermodal containers could be made from the composite laminate materials disclosed herein. Still further, the panels, liners and structures described herein also could be employed as part or all of an outer surface of the structures described herein such as trailers containers and so forth. In such cases, UV and/or wear resistance properties should be included in the structures. Refurbishment with use of the composite laminates, including panels, liners, and so forth made therefrom, also are included in embodiments.

It is further noted that for applications where weight is important and the puncture less important, a higher performance puncture resistance can be produced by, e.g., lowering the areal weight. For example for a 300 pound force puncture requirement, a 7034X (cross (X)-ply) could be used and achieve a significant weight savings. Accordingly, non-limiting embodiments also include composite laminates and panels, liners and so forth made therefrom capable of achieving a puncture resistance level of greater than or equal to 200 pounds of force, including greater than or equal to 300 pounds of force.

Additionally, it should be appreciated that while the composite laminates and, e.g., panels made therefrom, have been generally described in some embodiments as comprising two plies, embodiments are not limited in this regard as multiple plies can be employed, the composition of which will vary depending on the intended end use application. As such, for example, structures, such as panels, liners, containers, and so forth, comprising a ply of less expensive lower performing E-Glass fibers in a thermoplastic matrix comprising polyethylene and a ply of more expensive, higher performing S-Glass fibers also in a thermoplastic matrix comprising polyethylene can be fabricated.

It is further noted that according to embodiments and further applications, a segregated hybrid composite panel or liner can be employed. A hybrid composite panel comprises at least two different kinds of fibers are disposed, e.g., encapsulated, in at least one matrix material comprising polyethylene. As an example, the matrix material in the plies of a segregated hybrid panel may comprise polyethylene and various copolymers including, but not limited to, HDPE, LLDPE and LDPE, described above. In one illustrative embodiment, polyethylene having a modulus of 200,000 psi could be combined with a polyethylene of lower modulus (100,000 psi), which could improve the puncture resistance. Additionally a combination of a higher modulus (200,000 psi) polyethylene matrix that is exposed to the interior (e.g., first two layers) of, a container, or other structure, and backed up by a lower modulus (100,000 psi) back face with a matrix modulus that is about half the value could be employed, according to non-limiting embodiments.

It is further noted that the term “nonhybrid,” can be used to refer to panels or other materials that contain only a single kind of fiber. In contrast, segregated hybrid composite panels can comprise, e.g., lower-performing fibers concentrated in a portion (or stratum) of the panel at, or adjacent to, e.g., the outer face of the panel. The remainder of the segregated hybrid panel can comprises a “support portion,” which is adjacent the, e.g., outer face portion and which defines the back face of the panel; the higher-performing fibers are concentrated in the support portion of the panel, according to embodiments. The support portion of a segmented hybrid panel may comprise a “back face stratum” that defines the back face of the panel and an internal stratum between the back face stratum and the outer face portion. Accordingly, in some embodiments, at least one of the back face stratum and the internal stratum of the panel contains the higher-performing fibers. Optionally, a panel may comprise more than two kinds of fibers. In such case, it is possible, but not required, that the fibers be used in strata arranged from the outer face to the back face in order of increasing performance.

One example of a panel is a panel that has an outer face portion (first composite ply) principally comprising E-glass fibers as the lower-performing fibers in thermoplastic matrix comprising polyethylene, and a support portion (second composite ply) comprising S-glass fibers as the higher-performing fibers in thermoplastic matrix comprising polyethylene. Depending on the performance criteria for a particular panel, the thickness of the panel and the relative thicknesses of the E-glass and S-glass portions of the panel can vary. In one example, the S-glass plies and the E-glass plies are about equal in their weight contribution to the panel. In specific embodiments, the E-glass fibers may comply with ASTM D578-98, paragraph 4.2.2, and may have a roving yield of about 250-675 yards/pound (yd/lb.), or a roving tex of about 735-1985 grams/kilometer (g/km). The S-glass fibers may comply with ASTM C 162-90 and/or ASM 3832B, and may comprise filaments of a diameter of about 9 micrometers, have a roving tex of 675-1600 g/km or a yield of about 310-735 yards/lb.

According to embodiments, formation of a panel from plies comprising thermoplastic matrix materials to the substantial exclusion of thermosetting matrix materials can be achieved at lower pressure and for shorter periods than are needed for a thermosetting matrix material to cure. In addition, panels comprised of plies containing thermoplastic matrix material comprising polyethylene may require no degassing and generate little or no VOCs. Optionally, metals or ceramics or other materials can be added to a composite panel as described herein. Moreover, once fabricated, the panels and other structures described herein can be coated as desired, e.g., with a further composite, an elastomer, a metal housing etc. to protect against ultraviolet, moisture or other environmental influences. In addition, additives can be incorporated into the matrix material(s) for such things as fire resistance, smoke and toxicity resistance, and for cosmetic reasons

Accordingly, as evident from the foregoing descriptions, embodiments disclosed herein include a composite laminate, which includes at least two composite layers or plies, wherein a composite layer is a single layer comprising a polyethylene matrix with fibers embedded therein. In another embodiment, a laminate of two or more composite layers may contain composite layers that differ from each other with respect to the fibers and/or the orientation of the fibers in adjacent layers and/or with respect to the polyethylene matrix used in the multiple layer constructions. In yet another aspect, the composite layer with a polymer matrix is a low density polyethylene. In another aspect, the composite material has a surface layer composed of a non-fiber reinforced polyethylene outer layer which is positioned when installed on, e.g., a freight hauling container toward the cargo carrying side of the structure, thereby providing an outer surface that eliminates porosity, providing more stain resistance and rendering the liners easier to clean. This is due to the higher molecular weight polyethylene resins preferably used in the surface layer, resulting in an impervious, more robust panel surface. These structures with the smooth polyethylene outer layer substantially eliminate surface voids that attract dirt and moisture in existing types of cargo liners with fiber reinforced outer layer.

Further aspects reside in an apparatus and process for producing a composite laminate. The apparatus includes a first unwind station that includes at least one roll support assembly for rotatably supporting a roll of composite material. A tacking station is located downstream of the first unwind station and defines a tacking surface. A heating station is positioned downstream of the tacking station for heating the composite material fed from the roll in response to the composite material moving past the heater. The apparatus also includes a processing station including at least one calender roll assembly positioned downstream of the heating station.

Still further aspects reside in a method for making a composite laminate by positioning a plurality of lengths of composite material in adjacent relation to each other. The lengths of composite material are tacked together and the lengths of composite material are heated. The heated lengths of composite material are passed through a calender roll assembly to yield a composite laminate; and the composite laminate is collected.

Yet another aspect includes a method for making a composite laminate by powder coating or scattering of small particles on the outer surface of the composite which will then be heated and pressed and therefore laminated to the base structure as an alternative to films to provide a tough, durable and resistant outer layer. The particles/powder coating can comprise a composition exhibiting the desired properties of the outer layer, including but not limited to wear resistance, abrasion resistance, and so forth. As a further example, the particles/powder coating may also be antimicrobial materials which can be used for sanitary reasons in such applications as refrigerated container liners. The terms “first,” “second,” and the like, herein do not denote any order, quantity, or importance, but rather are used to distinguish one element from another. In addition, the terms “a” and “an” herein do not denote a limitation of quantity, but rather denote the presence of at least one of the referenced item. When a numerical phrase includes the term “about” the phrase is intended to include, but not require, the precise numerical value stated in the phrase. Moreover, it is noted that features of any and/or all embodiments described herein could be combined in any combination with any and/or all features of other embodiments disclosed herein.

Although the invention has been described with reference to particular embodiments thereof, it will be understood by one of ordinary skill in the art, upon a reading and understanding of the foregoing disclosure, that numerous variations and alterations to the disclosed embodiments will fall within the spirit and scope of this invention and of the appended claims.

It is to be understood that the present invention is by no means limited to the particular construction herein disclosed and/or shown in the drawings, but also comprises any modifications or equivalents within the scope of the disclosure.

What is claimed is:

1. A composite laminate comprising:
a plurality of composite plies including at least a first composite ply and a second composite ply, the first composite ply and the second composite ply each comprising a plurality of fibers in a thermoplastic matrix comprising polyethylene;
wherein the plurality of composite plies are bonded together to form the composite laminate.

2. The composite laminate of claim 1, wherein the plurality of fibers in the first composite ply are substantially parallel to each other, and the plurality of fibers in the second composite ply are substantially parallel to each other.

3. The composite laminate of claim 2, wherein the plurality of fibers in the first composite ply are disposed cross-wise to the plurality of fibers in the second composite ply.

4. The composite laminate of claim 3, wherein the plurality of fibers in the first composite ply are disposed cross-wise to the plurality of fibers in the second composite ply at an angle of greater than about 0 degrees to about 90 degrees.

5. The composite laminate of claim 4 wherein the plurality of fibers in the first composite ply are different from the plurality of fibers in the second composite ply.

6. The composite laminate of claim 4, wherein the plurality of fibers in the first composite ply are disposed cross-wise to the plurality of fibers in the second composite ply at an angle of about 15 degrees to about 75 degrees.

7. The composite laminate of claim 4, wherein the plurality of fibers in the first composite ply are disposed at about 90 degrees relative to the plurality of fibers in the second composite ply.

8. The composite laminate of claim 5, wherein the first composite ply and the second composite ply comprise fibers of different strength, and the first composite ply comprises E-glass fibers and the second composite ply comprises S-glass fibers.

9. A panel comprising the composite laminate of claim 3, wherein the panel achieves a puncture resistance level greater than about 560 pounds of force.

10. The panel of claim 9, wherein the panel achieves a puncture resistance level selected from the group consisting of: greater than about 570 pounds of force, greater than about 710 pounds of force and greater than about 750 pounds of force.

11. The panel of claim 9, wherein the panel achieves a puncture resistance level between about 560 pounds of force and about 760 pounds of force.

12. The panel of claim 11, wherein the panel achieves a puncture resistance level between about 570 pounds of force and about 760 pounds of force.

13. The panel of claim 12, wherein the panel achieves a puncture resistance level of between about 715 pounds of force and about 760 pounds of force.

14. The panel of claim 13, wherein the panel comprises a smooth outer layer comprising non-fiber reinforced polyethylene.

15. A liner comprising the panel of claim 9, wherein the liner is configured for a cargo carrier.

16. A scuff plate comprising the panel of claim 9, wherein the scuff plate is configured for a cargo carrier.

17. A subfloor comprising the panel of claim 9, wherein the subfloor is configured for a cargo carrier.

18. An aerodynamic side skirt comprising the panel of claim 9, wherein the aerodynamic side skirt is configured for a cargo carrier.

19. A method of making a composite laminate, comprising:
providing at least a first composite ply and a second composite ply, each of said first and second composite ply comprising a plurality of fibers in a thermoplastic matrix comprising polyethylene;
disposing the plurality of fibers in the first composite ply cross-wise to the plurality of fibers in the second composite ply; and
bonding the plurality of plies together to form a panel, wherein the panel achieves a puncture resistance level greater than or equal to about 300 pounds of force.

20. The method of claim 19, wherein the panel achieves a puncture resistance level selected from the group consisting of: greater than about 570 pounds of force, greater than about 710 pounds of force and greater than about 750 pounds of force.

21. A panel comprising the composite laminate of claim 3, wherein the panel achieves a puncture resistance level of greater than or equal to 200 pounds of force.

22. The panel of claim 21, wherein the panel achieves a puncture resistance level of greater than or equal to 300 pounds of force.

23. The method of claim 19 comprising:
depositing particles by powder coating or scattering the particles on an outer surface of the composite laminate;
heating the deposited particles; and
pressing the heated, deposited particles to form a durable outer layer.

24. The method of claim 19, wherein the particles comprise an antimicrobial material.

25. A fire resistant composite laminate comprising:
a plurality of composite plies including at least a first composite ply and a second composite ply, the first composite ply and the second composite ply each comprising a plurality of fibers in a thermoplastic matrix comprising polyethylene and comprising polyvinylidene fluoride (PVDF);
wherein the plurality of composite plies are bonded together to form the fire resistant composite laminate.

26. A ballistic panel comprising the fire resistant composite laminate of claim 25.
